(19) United States
(12) Patent Application Publication
(10) Pub. No.: US 2025/0193759 A1
(43) Pub. Date: Jun. 12, 2025

(54) TECHNIQUES FOR BACKSCATTER AND BACKSCATTER-AIDED ADVANCED COMMUNICATION

(71) Applicant: QUALCOMM Incorporated, San Diego, CA (US)

(72) Inventors: Ahmed ELSHAFIE, San Diego, CA (US); Huilin XU, Temecula, CA (US); Yuchul KIM, San Diego, CA (US); Zhikun WU, Beijing (CN); Linhai HE, San Diego, CA (US); Seyedkianoush HOSSEINI, San Diego, CA (US)

(21) Appl. No.: 18/846,244

(22) PCT Filed: Jun. 10, 2022
(86) PCT No.: PCT/CN2022/098043

§ 371 Date: Sep. 12, 2024

(51) Int. Cl. H04W 36/30; H04B 1/10; H04B 1/401; H04B 7/06; H04B 17/309; H04W 8/24; H04W 36/00; H04W 36/08

(52) U.S. Cl. CPC H04W 36/305; H04B 1/1027; H04B 1/401; H04B 7/06964; H04B 17/347; H04W 8/24; H04W 36/00222; H04W 36/085

(57) ABSTRACT

Certain aspects of the present disclosure provide techniques for backscatter and backscatter-aided advanced communication. An example method includes transmitting. to a network entity. UE capability information indicating that the UE supports a radio frequency identification (RFID)-based communication mode and an advanced communication mode and communicating with the network entity using at least one of the RFID-based communication mode or the advanced communication mode based on the CE capability information.

### BACKGROUND

### Field of the Disclosure

Aspects of the present disclosure relate to wireless communications, and more particularly, to techniques for backscatter and backscatter-aided advanced communication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE). The method includes transmitting, to a network entity, an indication of a preferred configuration for transmitting an energy signal to power one or more components of the first UE and receive the energy signal from the network entity based, at least in part, on the preferred configuration

One aspect provides a method for wireless communication by a second user equipment (UE). The method includes receiving, from a network entity, an indication of a selected configuration of an energy signal for powering a first UE, the selected configuration of an energy signal including a set of parameters, receiving one or more transmissions from the network entity, the one or more transmissions including the energy signal and one or more data signals, and performing an interference cancellation procedure based on the selected configuration of the energy signal to remove interference caused by the energy signal to the one or more data signals.

One aspect provides a method for wireless communication by a network entity. The method includes receiving, from a first use equipment (UE), an indication of a preferred configuration for transmitting an energy signal to power one or more components of the first UE and transmitting the energy signal based, at least in part, on the preferred configuration

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a radio frequency identification (RFID) system.

FIGS. 6 shows an example energy harvesting (EH)-based communication timeline illustrating communication between a network entity and EH-capable device.

FIG. 7 depicts a process flow for communications in a network between a network entity and a user equipment.

FIG. 8 depicts techniques for conveying different amounts of information via a response message.

FIG. 9 depicts a method for wireless communications.

FIG. 10 depicts another method for wireless communications.

FIG. 11 depicts aspects of an example communications device.

FIG. 12 depicts aspects of another example communications device.

### DETAILED DESCRIPTION

Aspects of the present disclosure provide apparatuses, methods, processing systems, and computer-readable mediums for backscatter and backscatter-aided advanced communication.

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or tags, that emit an information-bearing signal upon receiving an energizing signal. RFID devices may be operated without a battery, at low operating expense, low maintenance cost, and with a long-life cycle. Generally, RFID devices that are operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device.

Fifth and later generations of wireless technology may be expanded to support devices that are capable of harvesting energy from alternative energy sources (e.g., in lieu of or in combination with a battery). For example, these fifth and later generation devices (e.g., sometimes known as passive internet of things (PIoT) devices) harvest energy from wireless energy sources, such as RF signals, thermal energy, solar energy, etc. In some cases, the harvested energy may be used to charge an energy storage device. This stored harvest energy may then be used by the devices to support more advanced-type communications, such as fifth generation new radio (5G NR) or later generation communication.

However, while these techniques may allow for a wireless communication device to harvest and store energy from wireless energy sources that may be used later to support more advanced-type communication, a period of time required to perform this energy harvesting (EH) (e.g., to ensure there is enough stored harvest energy to support the advanced-type communications) may be significant. During this period of time, the wireless communication device may remain in a sleep state, which prevents a network entity, such as a base station, from keeping track of the wireless communication device and can lead to issues with security. These issues may also exit with traditional, non-energy harvesting devices that rely on a finite amount of energy in their storage devices between chargings and that periodically operate in a sleep state to conserve this finite amount of energy. Thus, technical problems exist with conventional techniques.

Accordingly, to avoid these issues, aspects of the present disclosure provide techniques for allowing a wireless communication device to communicate with a network entity using RFID-based communication in combination with more advanced types of communication. For example, during certain periods of time, the wireless communication device may be configured to communicate with the network entity while operating in an RFID-based communication mode. Communicating with the network entity while operating in the RFID-based communication mode may not require the wireless communication device to consume energy from an energy storage device. Instead, energy to support communication with the network entity while operating in the RFID-based communication mode may be harvested from an energy signal provided by the network entity and a portion of that energy reflected back towards the network entity, allowing the wireless communication device to maintain a minimum amount of communication with the network entity to avoid the tracking and security issues described above.

Further, during the period of time in which the wireless communication device is operating in the RFID-based communication mode, the wireless communication device may harvest energy from the energy signal provided by the network entity and store a portion of that energy in an energy storage device of the wireless communication device. Once a sufficient amount of energy has been stored in the energy storage device, the wireless communication device may switch to an advanced communication mode and use the stored harvest energy to communicate with the network entity using more advanced-type communications.

These technical solutions, among other things, allow for an exchange of control signaling between the network entity and wireless communication device to be maintained via RFID-based communication (e.g., without the need to consume power for a local energy storage device of the wireless communication device) even when the wireless communication device is in a sleep slate. This exchange of control signaling may allow the wireless communication device and network entity to remain synchronized even with the wireless communication device operates in the sleep state. Additionally, the RFID-based communication may be used to continually track a location signature or positioning of the wireless communication device, which may improve security between the wireless communication device and network entity. Additionally, as further described below, this RFID-based communication may be used to “sound” a channel between the wireless communication device and network entity without having to use stored energy to send reference signals using the advanced communication mode, thereby reducing power consumption at the wireless communication device. Additional benefits of these technical solutions are described below.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

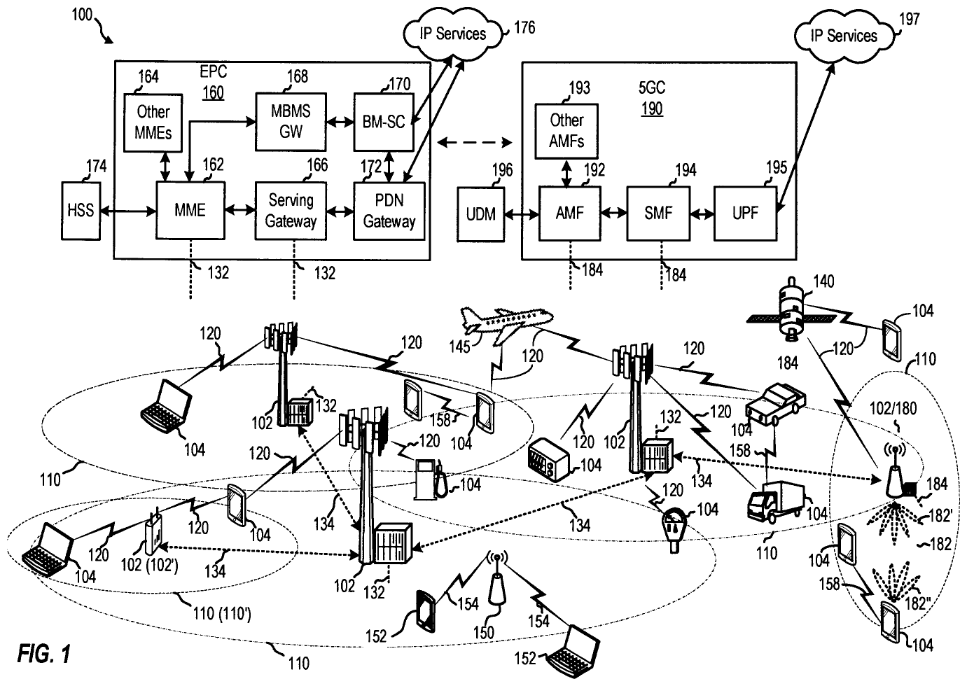

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

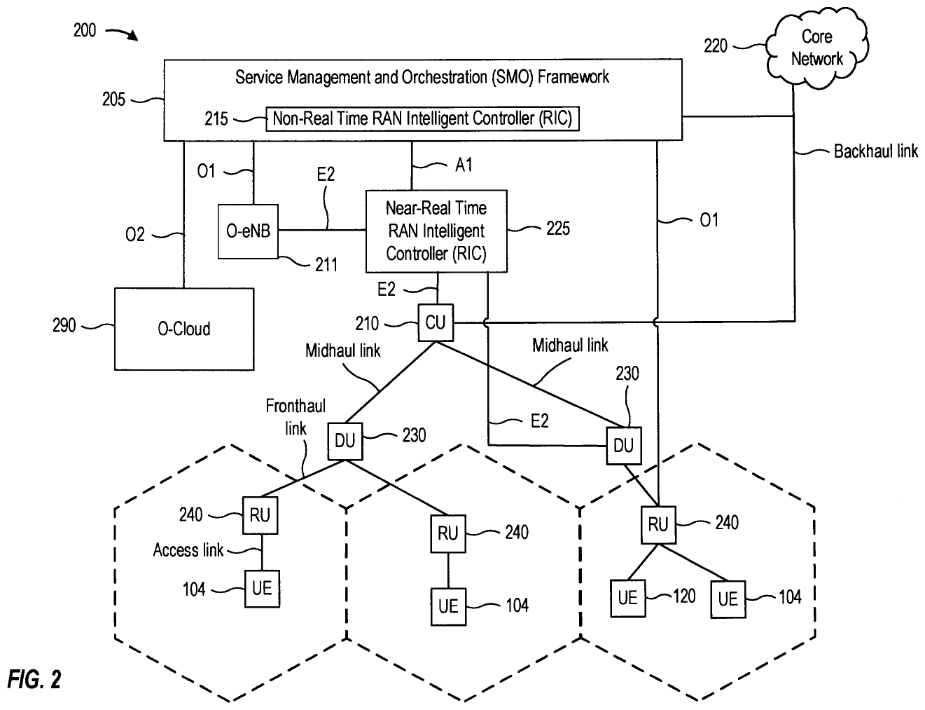

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

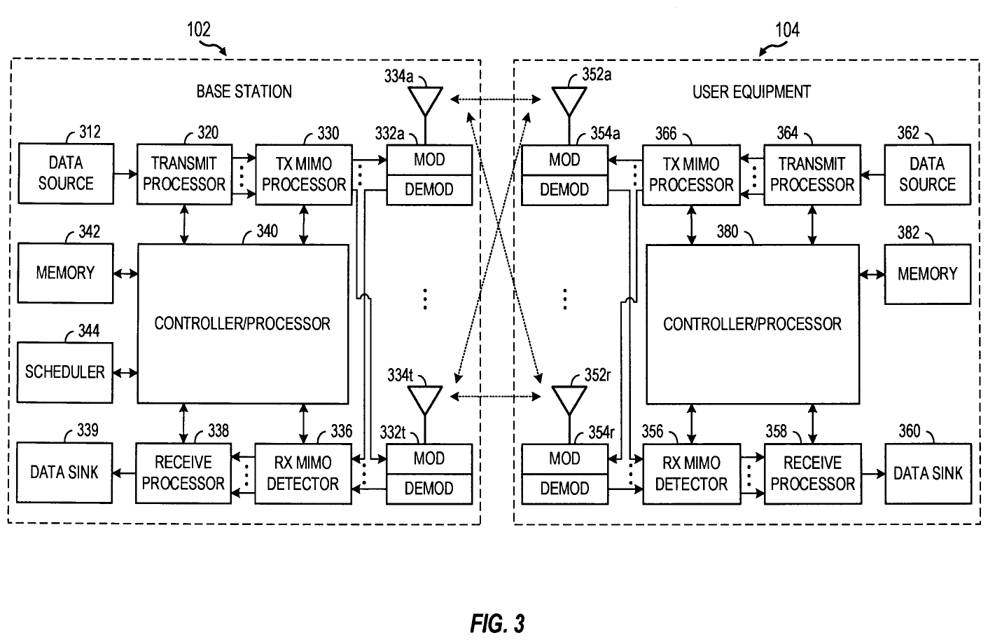

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

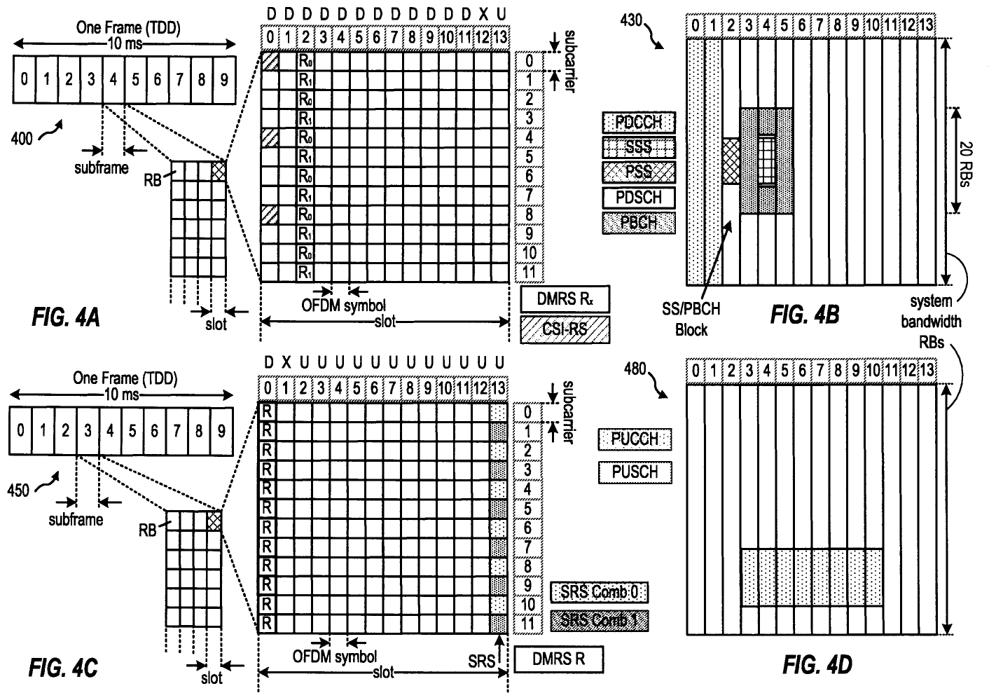

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in Radio Frequency Identification Systems

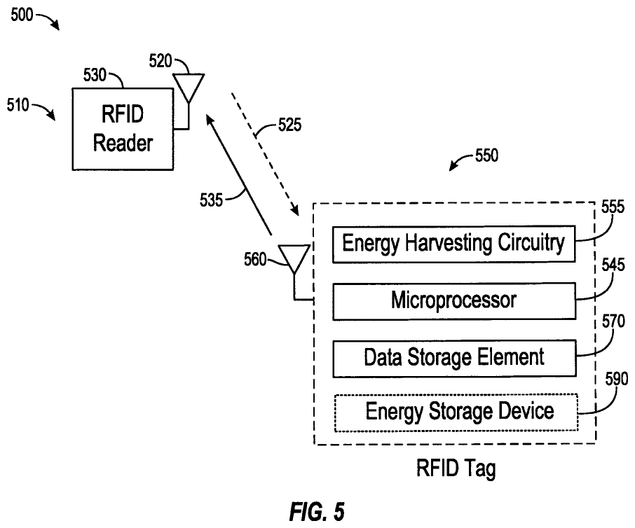

FIG. 5 shows an RFID system 500. As shown, the RFID system 500 includes an RFID reader 510 and an RFID tag 550. The RFID reader 510 may also be referred to as an interrogator or a scanner. The RFID tag 550 may also be referred to as an RFID label or an electronics label.

The RFID reader 510 includes an antenna 520 and an electronics unit 530. The antenna 520 radiates signals transmitted by the RFID reader 510 and receives signals from RFID tags and/or other devices. The electronics unit 530 may include a transmitter and a receiver for reading RFID tags such as the RFID tag 550. The same pair of transmitter and receiver (or another pair of transmitter and receiver) may support bi-directional communication with wireless networks, wireless devices, etc. The electronics unit 530 may include processing circuitry (e.g., a processor) to perform processing for data being transmitted and received by the RFID reader 510.

As shown, the RFID tag 550 includes an antenna 560 and a data storage element 570. The antenna 560 radiates signals transmitted by the RFID tag 550 and receives signals from the RFID reader 510 and/or other devices. The data storage element 570 stores information for the RFID tag 550, for example, in an electrically erasable programmable read-only memory (EEPROM) or another type of memory. The RFID tag 550 may also include an electronics unit that can process the received signal and generate the signals to be transmitted. The RFID tag 550 may be a passive RFID tag having no battery. In this case, induction may be used to power the RFID tag 550. For example, in some cases, a magnetic field from a signal transmitted by RFID reader 510 may induce an electrical current in RFID tag 550, which may then operate based on the induced current. The RFID tag 550 can radiate its signal in response to receiving a signal from the RFID reader 510 or some other device. In other cases, the RFID tag 550 may optionally include an energy storage device 590, such as a battery, capacitor, etc., for storing energy harvested using energy harvesting circuitry 555, as described below.

In one example, the RFID tag 550 may be read by placing the RFID reader 510 within close proximity to the RFID tag 550. The RFID reader 510 may radiate a first signal 525 via the antenna 520. In some cases, the first signal 525 may be known as an interrogation signal or energy signal. In some cases, energy of the first signal 525 may be coupled from the RFID reader antenna 520 to RFID tag antenna 560 via magnetic coupling and/or other phenomena. In other words, the RFID tag 550 may receive the first signal 525 from RFID reader 510 via antenna 560 and energy of the first signal 525 may be harvested using energy harvesting circuitry 555 (e.g., an RF transducer) and used to power the RFID tag 550. For example, energy of the first signal 525 received by the RFID tag 550 may be used to power a microprocessor 545 of the RFID tag 550. The microprocessor 545 may, in turn, retrieve information stored in a data storage element 570 of the RFID tag 550 and transmit the retrieved information via a second signal 535 using the antenna 560. For example, in some cases, the microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to the RFID reader 510. The RFID reader 510 may receive the second signal 535 from the RFID tag 550 via antenna 520 and may process (e.g., demodulate) the received signal to obtain the information of the data storage element 570 sent in the second signal 535.

In some cases, the RFID system 500 may be designed to operate at 13.56 MHz or some other frequency (e.g., an ultra-high frequency (UHF) band at 900 MHZ). The RFID reader 510 may have a specified maximum transmit power level, which may be imposed by the Federal Communication Commission (FCC) in the United Stated or other regulatory bodies in other countries. The specified maximum transmit power level of the RFID reader 510 may limit the distance at which RFID tag 550 can be read by RFID reader 510.

### Aspects Related to Backscatter and Backscatter-Aided Advanced Communication Techniques

Wireless technology is increasingly useful in industrial applications, such as ultra-reliable low-latency communication (URLLC) and machine type communication (MTC). In such domains, and others, it is desirable to support devices that are capable of harvesting energy from wireless energy sources (e.g., in lieu of or in combination with a battery or other energy storage device, such as a capacitor), such as RF signals, thermal energy, solar energy, and the like.

When RF signals are used for energy harvesting (EH), a first device (e.g., BS 102, a disaggregated BS as described with respect to FIG. 2, UE 104, or any other device described herein capable of transmitting wireless signals), may transmit an energy signal to a second device. The second device may then harvest energy from the energy signal (e.g., using EH circuitry, such as energy harvesting circuitry 555 illustrated in FIG. 5) and use this harvested energy to power one or more other components of the second device.

In addition to powering one or more components of the second device, the energy harvested from the energy signal may be used to reflect a signal back to the first device. The reflected signal may be generated based on energy signal received from the first device and a particular “on/off” pattern corresponding to bits of information needing to be transmitted by the second device. This type of communication may be known as backscatter communication.

In some cases, a portion the energy harvested from the energy signal (or from wireless energy sources) may be used to charge a local energy storage device of the second device for later use (i.e., the harvested energy may be stored in the local power storage device, such as the energy storage device 590 illustrated in FIG. 5). For example, the stored energy harvested from the energy signal from the first device may be used to facilitate more advance types of communication as opposed to backscatter communication, such as communications requiring full transceiver capability (e.g., transceivers 354 illustrated in FIG. 3) like 4G, 5G, or later generations of wireless communications systems. In some cases, as noted above, the stored energy may also be harvested from other sources, such as thermal energy, solar energy, mechanical energy (e.g., vibrations). In such cases, the second device

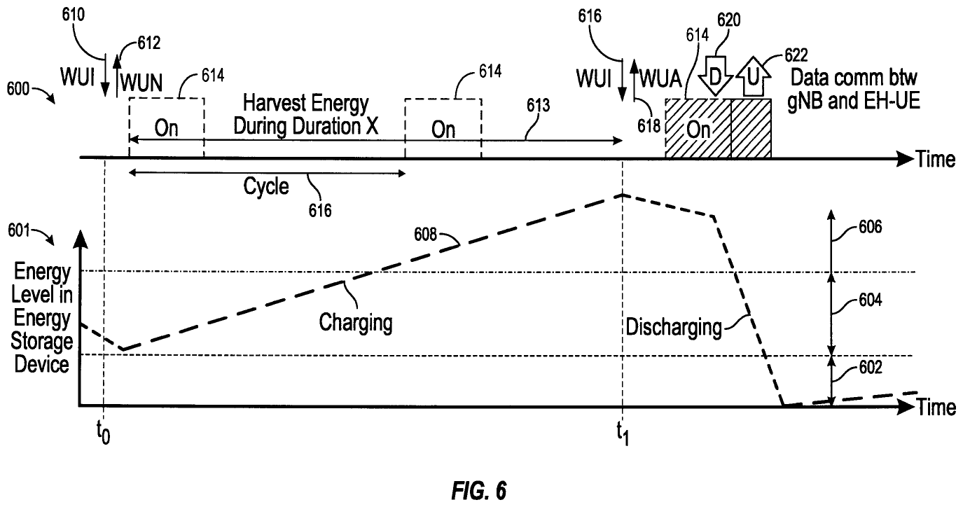

As noted, energy may be harvested by the second device from wireless energy sources, stored in a local energy storage device, and used to support advanced types of communications. The process of harvesting energy and storing it in the local energy storage device may be performed until enough energy (e.g., greater than or equal a threshold) has been harvested and stored to support these advanced types of communications, which may consume a relatively large period of time. During this period of time, the local energy storage device of the second device may pass through different charging states, each of which may be associated with a different level of communication functionality, as illustrated in FIG. 6.

FIG. 6 includes an example EH-based communication timeline 600 illustrating communications between a network entity (e.g., BS 102 described with respect to FIGS. 1 and 3 or a disaggregated base station described with respect to FIG. 2) and EH-capable device, such as UE 104 described with respect to FIGS. 1 and 3. Additionally, FIG. 6 includes a charging graph 601 illustrating different charging states associated with the EH-capable device (e.g., charging states of an energy storage device of the EH-capable device).

In this example, the charging graph 601 includes three different charging states associated with the EH-capable device, such as a first charging state 602, a second charging state 604, and a third charging state 606, each of which may be associated with a different level of communication functionality. The first charging state 602 may be a low charged state in which the EH-capable device may not have enough stored energy to transmit or receive information. The second charging state 604 may be a partially charged state in which the EH-capable device may only have enough stored energy to minimally communicate with a network entity, such as receiving a wake-up indication (WUI) message from the network entity and/or transmitting a wake-up acknowledgement (WUA) message or a wake-up notification (WUN) message to the network entity. The third charging state 606 may be a fully charged state in which the EH-capable device may have enough stored energy to perform more advanced communication (e.g., 4G, 5G, and others).

As shown at to in EH-based communication timeline 600, the EH-capable device receives a WUI message 610 from the network entity while an energy level 608 of the EH-capable device is within the second charging state 604. While the energy level 608 is second charging state 604 (or the first charging state 602), the EH-capable device may operate in a sleep state of a discontinuous reception (DRX) mode, allowing the EH-capable device to power down certain components, such as one or more transceivers (e.g., transceivers 354 illustrated in FIG. 3), one or more processors (e.g., controller/processor 380, transmit processor 364, and/or receive processor 358 illustrated in FIG. 3 as well as the microprocessor 545 illustrated in FIG. 5), one or more antennas (e.g., antennas 352 illustrated in FIG. 3 and antenna 560 illustrated in FIG. 5), etc. In some cases, this sleep state may also be known as an “OFF duration” of the DRX mode.

In some cases, the WUI message 610 received by the EH-capable device at to may indicate to the EH-capable device to wake up from the sleep state and to use an advanced communication mode (e.g., a 4G, 5G, or later communication mode) to receive data from the network entity (e.g., during a next “ON duration” of the DRX mode). In some cases, however, because the energy level 608 at time to is within the second charging state 604 (e.g., partially charged state), the EH-capable device may not be able to wake up and use the advanced communication mode to receive the data from the network entity. As a result, the EH-capable device transmits a WUN message 612, indicating to the network entity that the EH-capable device is unable to wake up and receive the data from the network entity.

In some cases, the EH-capable device may indicate within the WUN a length of time 613 needed for energy harvesting to allow the energy level 608 of the EH-capable device to rise to the third charging state 606 (e.g., fully charged). In some cases, the length of time 613 may be indicated as a unit of time (e.g., millisecond, seconds, symbols, slots, etc.) or as a number of cycles associated with an ON duration of DRX mode. For example, the DRX mode may schedule the EH-capable device with ON durations (e.g., a period of time during which the EH-capable device is awake), such as the ON durations 614, according to a particular periodicity. When not in an ON duration, the EH-capable device may remain in a sleep state (e.g., known as an OFF duration) to save power. A period of time between two of the ON durations 614 of the DRX mode may be known as a cycle. As such, rather than indicating the length of time for energy harvesting, the EH-capable device may instead indicate the length of time as the number of cycles (each cycle being associated with a defined period of time between ON durations of the DRX mode, in this example).

In some cases, in response to receiving the WUN indicating the length of time 613 needed for energy harvesting by the EH-capable device, the network entity may decide to forego transmitting WUI messages during this length of time since transmission of these WUI messages would fall within the second charging state 604 of the EH-capable device and, as such, the EH-capable device would still not be able to wake up and receive the data from the network entity.

During the length of time 613 needed for energy harvesting by the EH-capable device, the network entity may transmit an energy signal to the EH-capable device. As noted above, the energy signal may be used by the EH-capable device to harvest energy, which may be stored within a local energy storage device (e.g., a battery, a capacitor, etc.). Once the length of time 613 needed for energy harvesting has passed, the energy level 608 of the EH-capable device may be within the third charging state 606 (e.g., fully-charged).

Accordingly, as shown, the network entity may thereafter transmit WUI 616 at t₁ in EH-based communication timeline 600 after the length of time 613 needed for the energy harvesting. Because the energy level 608 at t₁ falls within the third charging state 606, the EH-capable device transmits WUA message 618 to the network entity, indicating that EH-capable device will wake up and use the advanced communication mode to receive the data from the network entity. For example, in response to receiving the WUI 616 and transmitting the WUA message 618, the EH-capable device may wake up one or more transceivers (e.g., transceivers 354 illustrated in FIG. 3), one or more processors (e.g., controller/processor 380, transmit processor 364, and/or receive processor 358 illustrated in FIG. 3 as well as the microprocessor 545 illustrated in FIG. 5), one or more antennas (e.g., antennas 352 illustrated in FIG. 3 and antenna 560 illustrated in FIG. 5), etc., causing the energy storage device of the EH-capable device to begin to discharge and the energy level 608 to decrease. The EH-capable device may then use the one or more transceivers to receive the data from the network entity according to the advanced communication mode, as shown at 620. The EH-capable device may also transmit information to the network entity using the advanced communication mode, as shown at 622.

While the techniques described above allow the EH-capable device to harvest energy from wireless energy sources (e.g., RF signals, thermal energy, mechanical energy, solar energy, etc.) and use this energy to facilitate advanced type communications, the EH-capable device may remain in a sleep state (e.g., a transceivers powered off) until the energy level 608 of the energy storage device is fully charged. Similar issues may also exist with non-EH-capable devices. While the EH-capable device is in the sleep state, the EH-capable device is generally not able to communicate with the network entity using advanced types of communication, which prevents the network entity from keeping track of the EH-capable device and can lead to issues with security. Additionally, while the techniques described above allow the EH-capable device to minimally communicate with the network device while in the sleep state, such as receiving a WUI from the network entity and transmitting a WUN or WUA to the network entity, this type of communication requires the EH-capable device to consume energy, which may increase the amount of time that the EH-capable device.

Similar issues may also exist for wireless communication devices that are not capable of harvesting energy from wireless energy sources. For example, such devices may include a local energy storage device (e.g., a battery) that relies on more traditional wired-charging or near-field-charging techniques to charge the energy storage device. In between wired chargings, these non-EH-capable wireless communication devices may completely rely on a finite amount of energy stored in the local energy device to operate. Due to this finite amount of energy, these type of non-EH-capable wireless communication devices may operate according to a DRX mode to conserve energy. For example, when not actively communicating with a network entity (e.g., BS 102), these non-EH-capable wireless communication devices may operate in a sleep state of the DRX mode. While in the sleep state, the non-EH-capable wireless communication devices are generally not able to communicate with the network entity using advanced types of communication, which prevents the network entity from keeping track of these non-EH-capable wireless communication and can lead to issues with security.

To help avoid the issues described above, aspects of the present disclosure provide techniques for allowing a wireless communication device (e.g., EH-capable and/or non-EH capable), such as the UE 104, to communicate with a network entity (e.g., BS 102) using RFID-based communication in combination with more advanced types of communication. For example, in some cases, the wireless communication device may be configured with an RFID-based communication module (e.g., similar to the RFID tag 550 illustrated in FIG. 5) that allows the wireless communication device to communicate with the network entity without consuming any energy stored within its local energy storage device.

More specifically, for example, the wireless communication device may include a full transceiver module (e.g., one or more of transceivers 354) capable of advance types of communication with the network entity while the wireless communication device is in an awake state (e.g., ON duration of a DRX mode). The wireless communication device may also include and RFID-based communication module capable of communicating (e.g., receiving and/or transmitting) with the network entity (without consuming any stored energy) while the wireless communication device is in a sleep state (e.g., OFF duration of the DRX mode).

In some cases, the wireless communication device may use the RFID-based communication module to receive a WUI (e.g., WUI message 610 illustrated in FIG. 6) from the network entity and respond with a WUA or WUN (e.g., WUN message 612 and WUA message 618 in FIG. 6) without consuming any stored energy.

Additionally, by including a RFID-based communication module, such as the RFID-tag 550 illustrated in FIG. 5, within a wireless communication device, an exchange of control signaling between the wireless communication device and network can be maintained via RFID-based communication even when the wireless communication device chooses to remain in the sleep state to conserve energy or does not have enough energy/power for advanced data communication. In some cases, this exchange of control signaling may allow the wireless communication device and the network entity to remain synchronized even when the wireless communication device loses its connection to the network entity due to power outage or remains in a sleep state for an extended period of time. Additionally, maintaining this control signaling may improve security within a wireless network in which the network entity and the wireless communication device operate. For example, maintaining this control signaling via RFID-based communication may allow for the continual monitoring of the wireless communication device's status, such as allowing the network entity to keep track of a location signature of the wireless communication device or to keep track of positioning of the wireless communication device.

Additional benefits of including a RFID-based communication module may include using an RFID-based communication mode to sound a channel between the wireless communication device and network entity without having to use stored energy to send sounding reference signals (SRSs) or channel state information reference signals (CSI-RSs) in an advanced communication mode. By not having to transmit SRSs or CSI-RSs, the wireless communication device may be able to repurpose energy (e.g., that would have originally been consumed for transmitting the SRSs and CSI-RSs) for other purposes.

Additionally, the techniques presented herein may be helpful in reducing interference within the wireless network. For example, in the case of the RFID-based communication mode, when a wireless communication device (e.g., a UE) receives a message (e.g., a WUI message) from the network entity, the wireless communication device may be configured to only transmit one response message (e.g., a WUN or WUA) to the message received from the network entity, thereby limiting the number of transmissions performed by the wireless communication device in the wireless network. In other words, but for the response message corresponding to the message received from the network entity, the wireless communication device may not continually use the RFID-based communication mode to transmit information. That is, the wireless communication device may only use the RFID-based communication mode to transmit information when this information is specifically requested by the network entity, thereby reducing interference caused by the wireless communication device in the wireless network (e.g., since the wireless communication device does not continually transmit using the RFID-based communication mode).

### Example Operations of Entities in a Communications Network

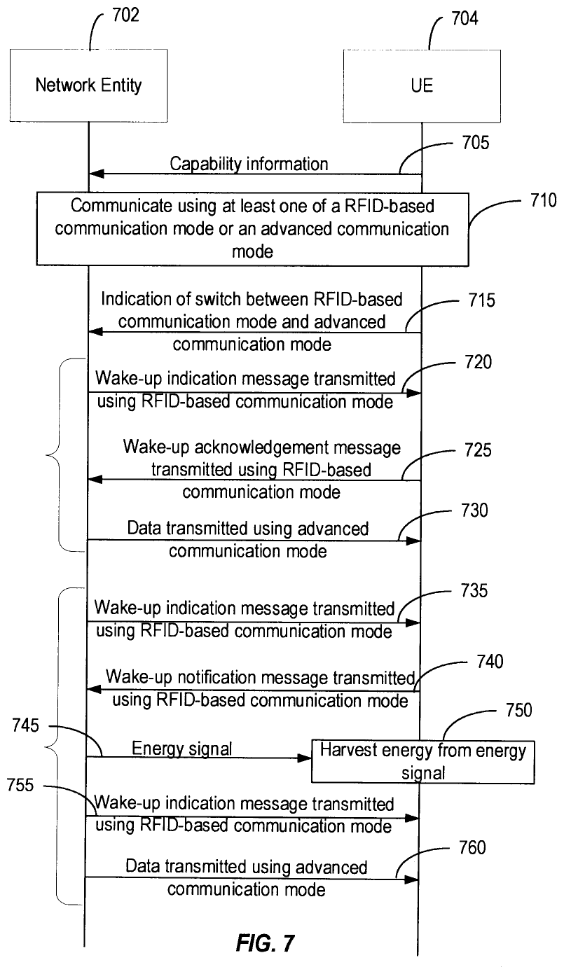

FIG. 7 depicts example operations 700 for communications in a network between a network entity 702 and a UE 704 in a wireless communications network. In some aspects, the network entity 702 may be an example of the BS 102 depicted and described with respect to FIGS. 1 and 3, a disaggregated base station depicted and described with respect to FIG. 2, or the UE 104 depicted and described with respect to FIGS. 1 and 3. In some cases, the network entity 702 may be capable of transmitting energy signals for powering one or more other devices, such as the UE 704.

In some cases, the UE 704 may be an example of UE 104 depicted and described with respect to FIGS. 1 and 3. In some cases, the UE 704 may include energy harvesting circuitry (e.g., energy harvesting circuitry 555 of FIG. 5) and may be capable of harvesting energy from the energy signals transmitted by the network entity 702 and storing the harvested energy in an energy storage device (e.g., energy storage device 590 illustrated in FIG. 5, such as a battery, a capacitor, or the like). In some cases, the UE 704 may include one or more full transceivers (e.g., transceivers 354), allowing the UE 704 to communicate with the network entity 702 using an advanced communication mode (e.g., using 4G, 5G, or higher communications). In some cases, the UE 704 may also include an RFID-based communication module (e.g., such as the RFID tag 550 illustrated in FIG. 5), allowing the UE 704 to communicate using an RFID-based communication mode involving the reception and transmission of signals that do not consume energy stored in a local energy storage device of the UE 704 (e.g., similar to the communication described with respect to FIG. 5.)

As shown, operations 700 begin in step 705 with the UE 704 transmitting, to the network entity 702, UE capability information. In some cases, the UE capability information may indicate that the UE supports an RFID-based communication mode and an advanced communication mode. In some cases, the advanced communication may comprise at least one of an LTE-based communication or a 5G NR-based communication. In some cases, the advanced communication mode comprises an energy harvesting (EH)-based communication mode. The EH-based communication mode may involves communication based on energy harvested from one or more wireless energy sources (e.g., EH-based LTE communication, EH-based 5G communication, etc.), such as at least one of a solar energy source, a vibration energy source, a thermal energy source, or an RF energy source (e.g., the first signal 525 in FIG. 5, also known as an energy signal).

Thereafter, as illustrated in in step 710, the UE 704 communicates with the network entity 702 using at least one of the RFID-based communication mode or the advanced communication mode based on the UE capability information. In some cases, because not all UEs may include an RFID-based communication module, the UE capability information may allow the network entity 702 to differentiate which UEs in a wireless communication network support RFID-based communications and which UEs do not support RFID-based communications. As such, because the UE capability information transmitted to the network entity 702 indicates that the UE 704 supports the RFID-based communication mode and the advanced communication mode, the network entity 702 and the UE 704 may communicate using the RFID-based communication mode and the advanced communication mode accordingly.

In some cases, communicating with the network entity 702 may include switching between using the RFID-based communication mode and using the advanced communication mode. In some cases, as illustrated in step 715, the UE 704 transmits a message to the network entity 702 indicating the switch between communicating using the RFID-based communication mode and communicating using the advanced communication mode. In some cases, the message indicating the switch may be transmitted in one of an early wake-up signal, a layer one (L1) control signal, a radio resource control (RRC) signal, or media access control-control element (MAC-CE) signal. In some cases, the L1 control signal may include DCI transmitted on a Uu communication link from the network entity 702 to the UE 704 or may include sidelink control information (SCI) transmitted on a sidelink communication link (e.g., PC5) from another (sidelink) UE to the UE 704.

In some cases, switching between using the RFID-based communication mode and using the advanced communication mode may be triggered in different manners. For example, in some cases, switching between using the RFID-based communication mode and using the advanced communication mode may be based on at least one of a path loss associated with communicating with the network entity 702. For example, in some cases, when communicating with the network entity 702 using the RFID-based communication mode, a path loss between the network entity 702 and UE 704 is greater than a threshold, the network entity 702 and UE 704 may switch to communicating using the advanced communication mode. In some cases, when communicating with the network entity 702 using the advanced communication mode, the path loss between the network entity 702 and UE 704 is less than or equal to the threshold, the network entity 702 and UE 704 may switch to communicating using the RFID-based communication mode.

In some cases, switching between using the RFID-based communication mode and using the advanced communication mode may be based a distance between the UE 704 and network entity 702. For example, in some cases, when communicating with the network entity 702 using the RFID-based communication mode, a distance between the network entity 702 and UE 704 is greater than a threshold, the network entity 702 and UE 704 may switch to communicating using the advanced communication mode. In some cases, when communicating with the network entity 702 using the advanced communication mode, the distance between the network entity 702 and UE 704 is less than or equal to the threshold, the network entity 702 and UE 704 may switch to communicating using the RFID-based communication mode.

In some cases, switching between using the RFID-based communication mode and using the advanced communication mode is based on an energy level of an energy storage device of the UE, such as a battery, capacitor, or the like. For example, if the energy storage device of the UE 704 is depleted (e.g., an amount of energy stored in the energy storage device is less than a threshold), the UE 704 may switch to using the RFID-based communication mode to communicate with the network entity 702. More specifically, in some cases, the UE 704 may be operating in the advanced communication mode. In such cases, when the energy level of the energy storage device is less than a threshold energy level, the UE 704 may switch from the communicating with the network entity 702 using the advanced communication mode to communicating using the RFID-based communication mode.

Otherwise, if the amount of energy stored in the energy storage device of the UE 704 is greater than or equal to the threshold, the UE 704 may switch to using the advanced communication mode to communicate with the network entity 702. More specifically, in some cases, the UE 704 may be operating in the RFID-based communication mode. In such cases, when the power energy of the energy storage device of the UE 704 is greater than or equal to a threshold energy level, the UE 704 may switch from the communicating with the network entity 702 using the RFID-based communication mode to communicating using the advanced communication mode.

In some cases, communicating with the network entity in step 710 may comprise using the RFID-based communication mode to communicate with the network entity 702. In some cases, the UE 704 may use the RFID-based communication mode by default in certain scenarios. For example, in some cases, in some cases, the UE 704 may use the RFID-based communication mode based on a period of time in which the UE 704 has no communication with the network entity 702 equaling or exceeding a threshold amount of time. In other words, when the UE 704 does not have any communication with the network entity 702 for greater than or equal to a threshold amount of time, the UE 704 may default to using the RFID-based communication mode to communicate with the network entity 702.

In some cases, the UE 704 may use the RFID-based communication mode based on a beam failure associated with a beam used for communicating with the network entity. For example, in some cases, the UE 704 may communicate with the network entity 702 in the advanced communication mode using one or more transmit or receive beams. In some cases, when one of these transmit or receive beams fail, the UE 704 may default back to communicating with the network entity 702 using the RFID-based communication mode.

Similarly, the UE 704 may use the RFID-based communication mode based on a radio link failure between the UE 704 and the network entity 702. For example, in some cases, the UE 704 may communicate with the network entity 702 in the advanced communication mode using a communication link, such a Uu communication link. In some cases, when the communication link fails and a radio link failure (RLF) is declared, the UE 704 may default back to communicating with the network entity 702 using the RFID-based communication mode.

In some cases, a first timer may be defined after which the UE 704 may be configured to fall back to using the advanced communication mode. For example, as noted above, communicating with the network entity in step 710 may comprise using the RFID-based communication mode to communicate with the network entity 702. In some cases, the UE 704 may communicate with the network entity 702 using the RFID-based communication mode for a period of time defined by the first timer. Upon expiration of the first timer, the UE 704 may switch to communicating with the network entity 702 using the advanced communication mode.

In some cases, a second timer may be defined after which the UE 704 may be configured fall back to communicating with the network entity 702 using the RFID-based communication mode. For example, in some cases, communicating with the network entity in step 710 may comprise communicating with the network entity 702 using the advanced communication mode. In some cases, the UE 704 may communicate with the network entity 702 using the advanced communication mode for a period of time defined by the second timer. Upon expiration of the second timer, the UE 704 may switch from communicating with the network entity 702 using advanced communication mode to communicating with the network entity 702 using the RFID-based communication mode.

More generally, communicating with the network entity 702 using the RFID-based communication mode and communicating with the network entity 702 using the advanced communication mode may be based on respective timers defined for each communication mode (e.g., the first timer and the second timer discussed above) upon expiration of which, the UE 704 is configured to switch communication modes. For example, when communicating using the RFID-based communication mode, the UE 704 may be configured to use timers defined for the RFID-based communication mode and, upon expiration of one or more of these timers, the UE 704 may switch to communicating using the advanced communication mode, as described above. Similarly, when communicating using the advanced communication mode, the UE 704 may be configured to use timers defined for the advanced communication mode and, upon expiration of one or more of these timers, the UE 704 may switch to communicating using the RFID-based communication mode. In some cases, the timers defined for the RFID-based communication mode may be different from the timers defined for the advanced communication mode (e.g., in terms of a configured amount of time defined for each timer). In some cases, these timers may include respective RRC inactive timers and RRC idle timers defined for the RFID-based communication mode and advanced communication mode.

In some cases, as shown in step 720, while the UE 704 is operating in the RFID-based communication mode, the UE 704 receives a WUI message from the network entity 702, such as the WUI message 610 illustrated in FIG. 6. In some cases, the WUI message may indicate to the UE 704 to wake up from a sleep state associated with the RFID-based communication mode and switch to communicating using the advanced communication mode. More specifically, for example, the WUI message may indicate that the network entity 702 has data to transmit to the UE 704 and for the UE 704 to wake up and switch to communicating using the advanced communication mode to receive the data from the network entity 702. In some cases, the UE 704 may receive the WUI message using the RFID-based communication mode without consuming any power stored in an energy storage device of the UE 704.

In some cases, the WUI message may be a sequence-based transmission (e.g., similar to PUCCH 0), comprising a sequence of bits. In some cases, the sequence of bits may be known to the UE 704 and indicate to the UE 704 to “wake up” and switch to the advanced communication mode. In some cases, the WUI message may indicate to the UE 704 to, in a next ON duration of a DRX mode in which the UE 704 is operating (e.g., assuming that the energy storage device of the UE 704 has a sufficient amount of energy), (1) wake up only a radio associated with the advanced communication mode (e.g., one or more of the components of the UE 104 shown in FIG. 3), (2) wake up both the radio associated with the advanced communication mode as well as a radio associated with the RFID-based communication mode (e.g., one or more of the components of the RFID tag 550 shown in FIG. 5), or (3) wake up only the radio associated with the RFID-based communication mode and keep the radio associated with the advanced communication mode in a sleep state.

In some cases, the UE 704 may generate a response message based on the WUI message. In some cases, to generate the response message, the UE 704 may perform analog amplification and one or more modification functions on the received WUI signal. For example, in some cases, when generating the response message, the UE 704 may flip a sign of the sequence of bits of the WUI message or may apply a phase shift (e.g., phase shift keying (PSK) modulation) (e.g., by multiplying the WUI signal by e^{-jφ}=−1 if φ=180°, where φ is the phase of the WUI signal) to the response message relative to a phase of the WUI message. The UE 704 may then transmit the response message to the network entity 702, for example, by forwarding the received WUI message including the modification functions.

The network entity 702 may detect the sign flip or phase shift in the response message and then determine an underlying payload associated with the response message. In some cases, a manner in which the response message is generated may differentiate between a type of information conveyed by the response message to the network entity 702. For example, when the network entity 702 receives a response message (e.g., in response to a transmitted WUI message) that includes a sign flip or phase shift relative to the WUI message, the network entity 702 may understand the sign flip or phase shift as indicating a particular response to the WUI message, such as indicating that the UE 704 is unable to switch to the advanced communication mode (e.g., similar to what is indicated by a WUN message) or indicating that the UE 704 will proceed ahead with switching to the advanced communication mode (e.g., similar to what is indicated by a WUA message). In some cases, generating a response message by simply flipping a sign or applying a phase shift associated with the received WUI message allows the UE 704 to respond to the received WUI message without having to use more complex data processing techniques that require the consumption of a significant amount of energy.

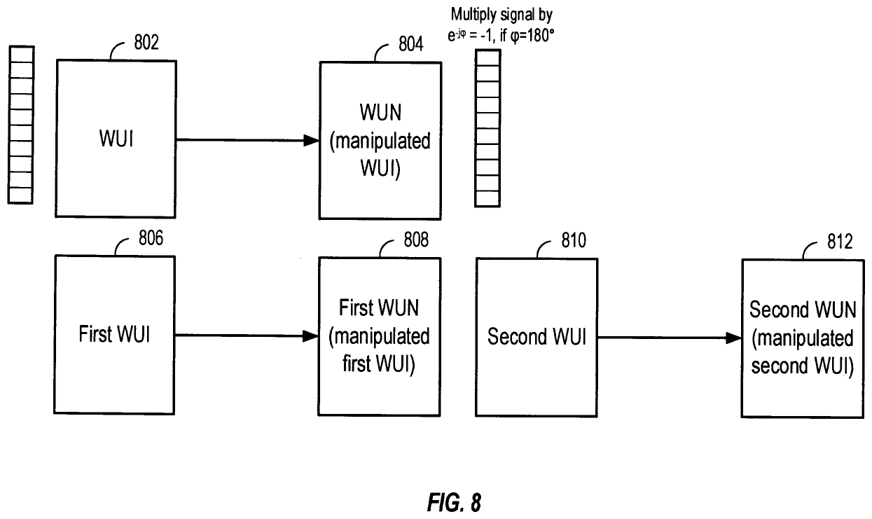

In some cases, the UE 704 may use the sign flip and/or phase shift techniques to convey different amounts of information via the response message. For example, as illustrated in FIG. 8, the UE 704 may receive a WUI message 802, which in some cases may include one bit of information. The UE 704 may then flip a sign of or apply a phase shift to the WUI message 802 to generate a response message, such as WUN message 804, which may be reflected/forwarded back to the network entity 702 using either the advanced communication mode or the RFID-based communication mode. In other words, the UE 704 may receive the WUI message 802 from the network entity 702, change the sign of or apply a phase shift to the WUI message 802 to generate the WUN message 804, and may transmit the WUN message 804 back to the network entity 702. Because the UE 704 is merely applying a phase shift to or flipping the sign of the WUI message 802, the WUN message 804 also includes one bit of information. In some cases, when sign flipping is used to generate the WUN message 804 with one bit, the WUN message 804 may be capable of indicating two different responses. For example, a positive sign (+) associated with the WUN message 804 may indicate one response while a negative sign (−) may indicate another response.

In some cases, if additional information or responses need to be indicated to the network entity 702, a two-stage information delivery technique may be used. For example, in some cases, the UE 704 may receive a first WUI message 806 from the network entity 702, which may include one bit of information. The UE 704 may then flip a sign of or apply a phase shift to the first WUI message 806 to generate a response message, such as a first WUN message 808, which may be reflected/forwarded back to the network entity 702 using either the advanced communication mode or the RFID-based communication mode. In other words, the UE 704 may receive the first WUI message 806 from the network entity 702, change the sign of or apply a phase shift to the first WUI message 806 to generate the first WUN message 808, and may transmit the first WUN message 808 back to the network entity 702. Because the UE 704 is merely applying a phase shift to or flipping the sign of the first WUI message 806, the first WUN message 808 also includes one bit of information. As noted above, when sign flipping is used to generate the first WUN message 808 with one bit, the first WUN message 808 may be capable of indicating two different responses. For example, a positive sign (+) associated with the first WUN message 808 may indicate one response while a negative sign (−) may indicate another response.

Thereafter, the UE 704 may receive a second WUI message 810 from the network entity 702, which may include one bit. The UE 704 may then flip a sign of or apply a phase shift to the second WUI message 810 to generate a response message, such as a second WUN message 812, which may be reflected/forwarded back to the network entity 702 using either the advanced communication mode or the RFID-based communication mode. Because the UE 704 merely applies a phase shift to or flips the sign of the second WUI message 810, the second WUN message 812 also includes one bit of information. As such, when sign flipping is used to generate the second WUN message 812 with one bit, the second WUN message 812 may be capable of indicating two different responses. For example, as noted above, a positive sign (+) associated with the second WUN message 812 may indicate one response while a negative sign (−) may indicate another response.

Accordingly, the first WUN message 808 and second WUN message 812, which may each include one bit capable of indicating two responses (e.g., + or −), the signs associated with the bits of the first WUN message 808 and second WUN message 812 may be used by the UE 704 to indicate up to four different responses. For example, a first response may be indicated using a negative sign (−) associated with the first WUN message 808 and a negative sign (−) associated with the second WUN message 812. A second response may be indicated using a negative sign (−) associated with the first WUN message 808 and a positive sign (+) associated with the second WUN message 812. A third response may be indicated using a positive sign (+) associated with the first WUN message 808 and a negative sign (−) associated with the second WUN message 812. Finally, a fourth response may be indicated using a positive sign (+) associated with the first WUN message 808 and a positive sign (+) associated with the second WUN message 812.

In some cases, the response message transmitted by the UE 704 to the network entity 702 may comprise a WUA message, such as the WUA message 618 illustrated in FIG. 6, and may be transmitted to the network entity 702 using the RFID-based communication mode. For example, based on the WUI message received from the network entity 702 in step 720 of FIG. 7, the UE 704 transmits a WUA message to the network entity 702 using a backscatter signal associated with the RFID-based communication mode, as shown in step 725 of FIG. 7. In some cases, the WUA message indicates that the UE 704 will switch to communicating using the advanced communication mode.

In some cases, transmitting the WUA message using the backscatter signal comprises may include receiving an energy signal from the network entity 702 and reflecting a portion of the received energy signal modulated with a known preamble or modulation sequence (e.g., a reference signal sequence) or modulated with a single complex number (e.g., e^{-jφ}) that indicates that the UE will switch to communicating using the advanced communication mode. In some cases, the energy signal may be transmitted to the UE 704 in combination with (or separate from) the WUI message.

Thereafter, based on the WUI message and WUA message, communicating with the network entity 702 may include switching from the RFID-based communication mode to the advanced communication mode and receiving data (e.g., indicated in the WUI message) from the network entity 702 using the advanced communication mode, as shown in step 730 of FIG. 7.

As noted above, in some cases, the UE 704 may receive a WUI message from the network entity 702 while operating in the RFID-based communication mode, as shown in step 735. The WUI message indicates to the UE 704 to switch to communicating using the advanced communication mode to receive data from the network entity 702. In response to the WUI message, the UE 704 transmits a response message to the network entity 702, such as a WUN message (e.g., WUN message 612 illustrated in FIG. 6), in step 740 of FIG. 7. In some cases, the WUN message may be transmitted to the network entity 702 using a backscatter signal associated with the RFID-based communication mode.

In some cases, similar to transmitting the WUA message described above, transmitting the WUN message using the backscatter signal may include receiving an energy signal from the network entity and reflecting a portion of the received energy signal modulated with a known preamble or modulation sequence (e.g., a reference signal sequence) or modulated with a single complex number (e.g., e^{-jφ}) that indicates that the UE 704 is unable to switch to the advanced communication mode.

In some cases, the WUN message may indicate that the UE is unable to switch to the advanced communication mode for a period of time. Further, in some cases, the WUN message may also comprise an indication of a length of the period of time. The UE 704 may transmit the WUN message to indicate that the UE 704 is unable to switch to the advanced communication mode for certain reasons, such as an energy storage device of the UE 704 not having a sufficient amount of power to support communicating using the advanced communication mode. For example, as noted above, in some cases, the UE 704 may be capable of harvesting energy from wireless energy sources, such as energy signals transmitted by the network entity 702 as well as other means (e.g., solar energy, vibration energy, etc.). In some cases, the UE 704 may use this harvested energy to charge the energy storage device, which the UE 704 may then use to communicate using the advance communication mode.

As a result, the energy storage device may have different charging states, such as the first charging state 602, the second charging state 604, and the third charging state 606 as described with respect to FIG. 6. Because, as noted above with respect to FIG. 6, the UE 704 may not be capable of advanced-type communications when the energy storage device is in the first charging state 602 or the second charging state 604, there is a period of time during which the UE 704 must harvest energy until the energy storage device reaches the third charging state 606 (e.g., fully charged) and is capable of the advanced-type communications. As such, the UE 704 may indicate this period of time to the network entity 702 so that the network entity 702 knows when the UE 704 is capable of “waking-up” to receive data from the network entity 702.

Accordingly, based on the WUN message transmitted to the network entity 702 and assuming that an amount of energy stored in the energy storage device is below a threshold amount of energy (e.g., the energy storage device does not have enough stored energy to support advanced communications), the UE 704 may begin to harvest energy from a wireless energy source and store that energy in the energy storage device.

More specifically, for example, the UE 704 may receive an energy signal from the network entity 702 as illustrated in step 745. In some cases, the UE 704 may harvest energy from other wireless energy sources (e.g., solar energy, vibration energy, heat energy, etc.) in addition to or in lieu of the energy signal from the network entity 702. The UE 704 may then use energy harvesting circuitry (e.g., energy harvesting circuitry 555 of FIG. 5) to harvest energy from the energy signal during the period of time indicated in the WUN message, as shown in step 750. The UE 704 may store the harvested energy in the energy storage device of the UE 704, as described above.

After the period of time indicated in the WUN message during which the energy is harvested by the UE 704 from the energy signal, the energy storage device of the UE 704 may have a sufficient amount of energy (e.g., greater than or equal to the threshold amount of energy) to support communicating using the advanced communication mode. As a result, the UE 704 may switch from the RFID-based communication mode to the advanced communication mode and may use the advanced communication mode and the stored harvested energy to receive data from the network entity 702, as shown in step 760 of FIG. 7.

In some cases, as shown in step 755, the UE 704 may receive another WUI message from the network entity 702 after the period of time during which the energy is harvested from the energy signal. In such cases, the UE 704 may switch to the advanced communication mode to receive the data from the network entity 702 in step 760 based on the other WUI message received from the network entity 702.

In some cases, a WUI message (e.g., WUI message 610 of FIG. 6) may indicate a number of PDCCHs or PDCCHs+PDSCHs the UE 704 is expected monitor for and decode during a next ON duration of a DRX mode. In some cases, the response message (e.g., WUN message 612 or WUA message 618 of FIG. 6) transmitted by the UE 704 may indicate whether the UE 704 accepts the indicated number of PDCCHs or PDCCHs+PDSCHs to monitor and decode. In some cases, the response message (e.g., WUN message or WUA message) transmitted by the UE 704 may indicate whether the UE 704 supports a greater or lesser number of PDCCHs or PDCCHs +PDSCHs to monitor and decode.

In some cases, when the response message transmitted by the UE 704 comprises a WUN message, the WUN message may indicate an average time to wake up during a DRX ON duration (e.g., active time). In some cases, the WUI message may cause the UE 704 to wake up or not for at least K downlink or sidelink transmissions. In some cases, K may be as small as one downlink/sidelink transmission and may be RRC or MAC-CE configured. Additionally, in some cases, K may be adaptively changeable based on a charging rate and/or an amount of energy that is stored in an energy storage device of the UE 704. In some cases, as described above, the WUN may indicate that the UE 704 is able to wake up (e.g., to receive data transmitted by the network entity 702 using the advanced communication mode) or that the UE 704 requires additional time to sleep and harvest energy.

In some cases, while the RFID-based communication mode may be used to communicate WUI, WUA, and WUN messages between the network entity 702 and UE 704 without the need for the UE 704 to consume energy stored in a local energy storage device, the RFID-based communication mode may also be used to support other functions without the need for the UE 704 to consume energy stored in a local energy storage device. For example, in some cases, the RFID-based communication mode may be used by the network entity 702 and UE 704 to keep track of channel properties (time/frequency errors, radio resource management (RRM) measurements) of a channel used for communication between the UE 704 and network entity 702 as well as keeping track of average statistics of the channel (e.g., reference signal received power (RSRP), reference signal received quality (RSRQ), etc.).

Accordingly, for example, in some cases, the UE 704 may receive a signal from the network entity 702 using the RFID-based communication mode and may perform a channel estimation procedure for a channel used for the communication with the network entity 702 based on the received signal. In some cases, the signal received from the network entity 702 may include a reference signal with a particular sequence known to both the UE 704 and network entity 702.

Similarly, the network entity 702 may receive a signal from the UE 704 using the RFID-based communication mode and may also perform a channel estimation procedure for a channel used for the communication with the UE 704 based on the received signal. In some cases, the signal received from the UE 704 may include a reference signal with a particular sequence known to both the UE 704 and network entity 702.

In some cases, performing the channel estimation procedure may include measuring at least one of a time or frequency error associated with communications between the UE 704 and the network entity 702. In some cases, performing the channel estimation procedure may include performing one or more radio resource management measurements associated with communications between the UE 704 and the network entity 702. In some cases, performing the channel estimation procedure may include measuring an RSRP associated with communications between the UE 704 and the network entity 702. In some cases, performing the channel estimation procedure may include measuring an RSRQ associated with communications between the UE 704 and the network entity 702.

In some cases, because the measurements performed during the channel estimation procedures conducted by the UE 704 and network entity 702 may be unique to a channel between the UE 704 and network entity 702 (e.g., and therefore only knowable by UE 704 and network entity 702), the channel estimation procedure may be used to generate security keys to secure the communication between the UE 704 and network entity 702.

For example, in some cases, the UE 704 may generate one or more security keys based on the signal received from the network entity 702 and the channel estimation procedure that was performed by the UE 704 (e.g., using one or more of the measurements performed during the channel estimation procedure). Thereafter, the UE 704 may use the one or more security keys to encrypt messages transmitted by the UE 704 to the network entity 702. Further, because the network entity 702 also performed the channel estimation procedure and may have the same measurements, the network entity 702 is capable of also generating the one or more security keys and using the one or more security keys to decrypt the messages transmitted by the UE 704 to the network entity 702. Similarly, the network entity 702 may also use the one or more security keys to encrypt messages transmitted by the network entity 702 to the UE 704 and the UE 704 may use the one or more security keys to decrypt these messages.

In some cases, the process for generating the one or more security keys may be as follows. For example, network entity 702 and UE 704 may first send reference signals to each other, in some cases, using the RFID-based communication mode. Thereafter, each of the network entity 702 and UE 704 may estimate (e.g., measure) the channel between the network entity 702 and UE 704 based on the reference signals to obtain certain channel metrics, such as channel power, RSRP, signal-to-noise ratio (SINR), phase, or the like. Thereafter, to generate the one or more security keys, the network entity 702 and UE 704 may quantize the channel metric or use it as an input to a key derivation function, such as a hash-based message authentication code based on a 256-bit secure hash algorithm (HMAC-SHA-256). As noted above, the network entity 702 and UE 704 may then use the one or more security keys to encrypt and decrypt messages transmitted between the network entity 702 and UE 704.

In some cases, in addition to performing channel estimation procedures and generating security keys, the RFID-based communication mode may be used to track a location of the UE 704. For example, the network entity 702 may transmit an energy signal to the UE 704 and, in some cases, a UE-location request message indicating to the UE 704 to transmit a response message including location information associated with the UE 704. The UE 704 may receive the energy signal (and UE-location request message) and may reflect a portion of the energy signal back to the network entity 702. In some cases, the UE 704 may include location information associated with the UE 704 in the portion of the energy signal reflected back to the network entity 702. Accordingly, such techniques may allow the network entity 702 to track the location of the UE 704 even when the UE 704 is in a sleep state or when the energy storage device of the UE 704 is depleted. Moreover, these techniques allow the network entity 702 to track the location of the UE 704 without the need for the UE 704 to consume energy stored in the energy storage device.

### Example Operations of a User Equipment

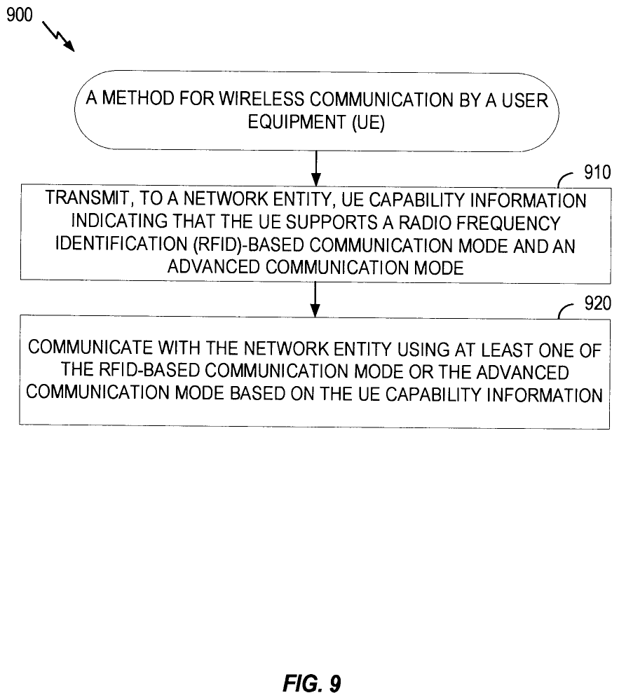

FIG. 9 shows a method 900 for wireless communications by a UE, such as UE 104 of FIGS. 1 and 3, the RFID-tag 550 illustrated in FIG. 5, or the UE 704 described with respect to FIG. 7.

Method 900 begins at 910 with transmitting, to a network entity, UE capability information indicating that the UE supports an RFID-based communication mode and an advanced communication mode.

Method 900 then proceeds to step 920 with communicating with the network entity using at least one of the RFID-based communication mode or the advanced communication mode based on the UE capability information.

In some cases, communicating with the network entity in step 920 comprises switching between using the RFID-based communication mode and using the advanced communication mode.

In some cases, the switching between using the RFID-based communication mode and using the advanced communication mode is based on at least one of a path loss associated with communicating with the network entity or a distance between the UE and network entity.

In some cases, the switching between using the RFID-based communication mode and using the advanced communication mode is based on an energy level of an energy storage device of the UE.

In some cases, communicating with the network entity in step 920 comprises communicating with the network entity using the RFID-based communication mode. In some cases, method 900 further includes determining, while communicating with the network entity using the RFID-based communication mode, the energy level of the energy storage device of the UE is greater than or equal to a threshold energy level. In some cases, method 900 further includes switching, based on the energy level being greater than or equal to the threshold energy level, from communicating using the RFID-based communication mode to communicating using the advanced communication mode.

In some cases, communicating with the network entity in step 920 comprises communicating with the network entity using the advanced communication mode. In some cases, method 900 further includes determining, while communicating with the network entity using the advanced communication mode, the energy level is less than a threshold energy level. In some cases, method 900 further includes switching, based on the energy level being less than the threshold energy level, from communicating using the advanced communication mode to communicating using the RFID-based communication mode.

In some cases, method 900 further includes transmitting a message to the network entity indicating the switch between communicating using the RFID-based communication mode and communicating using the advanced communication mode.

In some cases, transmitting the message indicating the switch comprises transmitting the message indicating the switch in one of: an early wake-up signal or an RRC signal or MAC-CE signal.

In some cases, communicating with the network entity in step 920 comprises communicating with the network entity using the RFID-based communication mode.

In some cases, communicating with the network entity using the RFID-based communication mode is based on a period of time in which the UE has no communication with the network entity equaling or exceeding a threshold amount of time. In some cases, communicating with the network entity using the RFID-based communication mode is based on a beam failure associated with a beam used for communicating with the network entity. In some cases, communicating with the network entity using the RFID-based communication mode is based on a radio link failure between the UE and the network entity.

In some cases, method 900 further includes switching from communicating with the network entity using the RFID-based communication mode to communicating with the network entity using the advanced communication mode upon expiration of a timer.

In some cases, method 900 further includes receiving, while communicating with the network using the RFID-based communication mode, a wake-up indication message from the network entity indicating to the UE to switch from communicating with the network entity using the RFID-based communication mode to communicating using the advanced communication mode to receive data from the network entity.

In some cases, the wake-up indication message comprises a sequence of bits. In such cases, method 900 may further include generating a response message based on the wake-up indication message and transmitting the response message to the network entity.

In some cases, generating the response message comprises one of: flipping a sign of the sequence of bits of the wake-up indication message or applying a phase shift to the response message relative to a phase of the wake-up indication message.

In some cases, a manner in which the response message is generated differentiates between types of information conveyed by the response message to the network entity.

In some cases, method 900 further includes transmitting, using a backscatter signal associated with the RFID-based communication mode, a wake-up acknowledgement message to the network entity based on the received wake-up indication message, the wake-up acknowledgement message indicating that the UE will switch to communicating using the advanced communication mode.

In some cases, communicating with the network entity in step 920 includes switching from the RFID-based communication mode to the advanced communication mode based on the wake-up indication message and receiving the data from the network entity using the advanced communication mode.

In some cases, transmitting the wake-up acknowledgement message using the backscatter signal comprises: receiving an energy signal from the network entity and reflecting a portion of the received energy signal with a preamble or modulation sequence that indicates that the UE will switch to communicating using the advanced communication mode.

In some cases, method 900 further includes transmitting, using a backscatter signal associated with the RFID-based communication mode, a wake-up notification message to the network entity based on the received wake-up indication message, the wake-up notification message indicating that the UE is unable to switch to the advanced communication mode for a period of time. In some cases, the wake-up notification message comprises an indication of a length of the period of time.

In some cases, transmitting the wake-up notification message using the backscatter signal comprises: receiving an energy signal from the network entity and reflecting a portion of the received energy signal with a preamble or modulation sequence that indicates that the UE is unable to switch to the advanced communication mode.

In some cases, method 900 further includes receiving an energy signal from the network entity, harvesting energy from the energy signal during the period of time, and storing the harvested energy in an energy storage device of the UE.

In some cases, method 900 further includes switching from the RFID-based communication mode to the advanced communication mode after the period of time during which the energy is harvested from the energy signal. In some cases, communicating with the network entity in step 920 comprises using the advanced communication mode and the stored harvested energy to receive the data from the network entity.

In some cases, method 900 further includes receiving another wake-up indication message from the network entity after the period of time during which the energy is harvested from the energy signal. In some cases, the switching to the advanced communication mode is based on the other wake-up indication message.

In some cases, method 900 further includes receiving a signal from the network entity using the RFID-based communication mode and performing a channel estimation procedure for a channel used for the communication with the network entity based on the received signal.

In some cases, performing the channel estimation procedure comprises at least one of: measuring at least one of a time or frequency error associated with communications between the UE and the network entity, performing one or more radio resource management measurements associated with communications between the UE and the network entity, measuring an RSRP associated with communications between the UE and the network entity, or measuring an RSRQ associated with communications between the UE and the network entity.

In some cases, method 900 further includes generating one or more security keys based on the signal and the channel estimation procedure. In such cases, communicating with the network entity in step 920 is based on the one or more security keys.

In some cases, the advanced communication comprises at least one of LTE-based communication or 5G NR-based communication.

In some cases, communicating with the network entity in step 920 comprises communicating with the network entity using the advanced communication mode. In some cases, the advanced communication mode comprises an EH-based communication mode that involves communication based on energy harvested from one or more wireless energy sources, including at least one of a solar energy source, a vibration energy source, a thermal energy source, or a RF energy source.

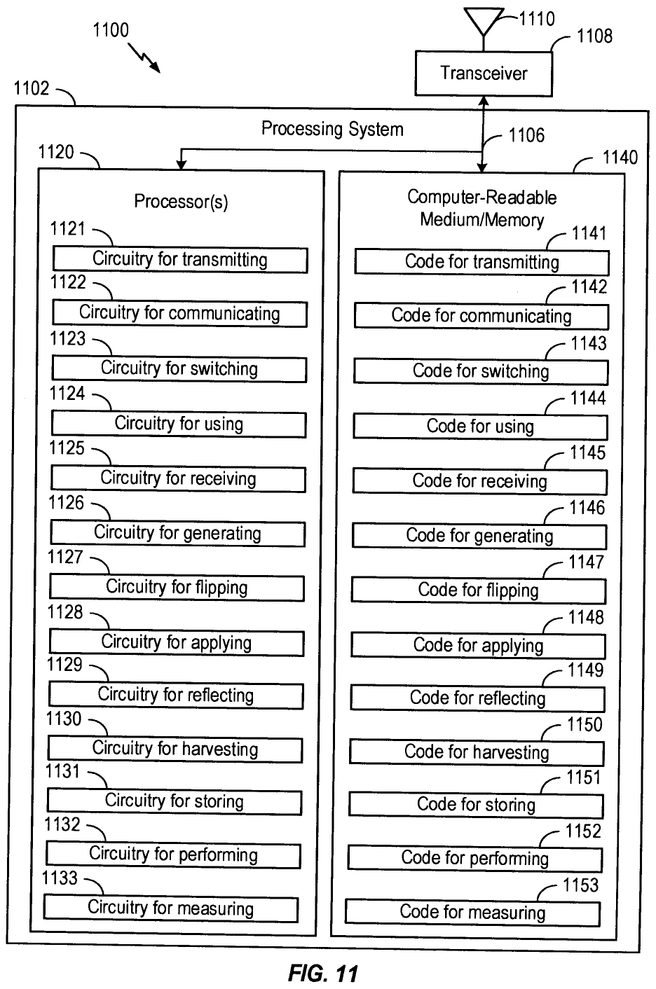

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

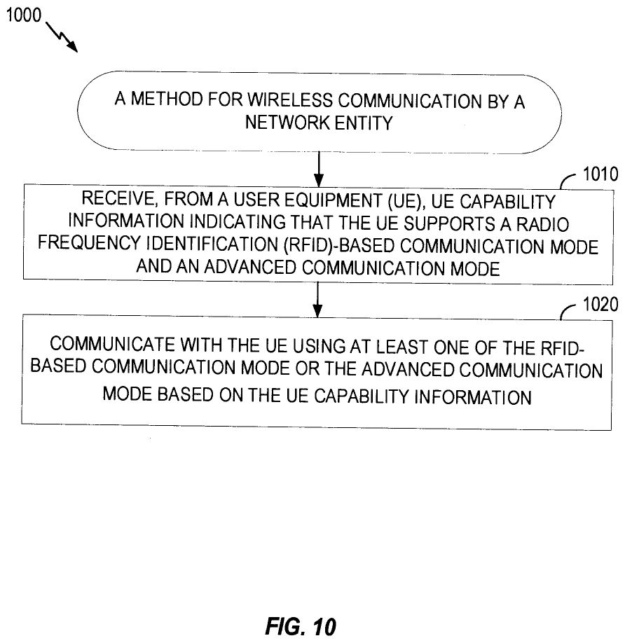

FIG. 10 shows a method 1000 for wireless communications by a network entity, such as BS 102 of FIGS. 1 and 3, or a disaggregated base station as discussed with respect to FIG. 2.

Method 1000 begins at 1010 with receiving, from a UE, UE capability information indicating that the UE supports a RFID-based communication mode and an advanced communication mode.

Method 1000 then proceeds to step 1020 with communicating with the UE using at least one of the RFID-based communication mode or the advanced communication mode based on the UE capability information.

In some cases, communicating with the UE in step 1020 comprises switching between using the RFID-based communication mode and using the advanced communication mode.

In some cases, the switching between using the RFID-based communication mode and using the advanced communication mode is based on at least one of a path loss associated with communicating with the UE or a distance between the UE and network entity.

In some cases, method 1000 further includes receiving a message from the UE indicating the switch between communicating using the RFID-based communication mode and communicating using the advanced communication mode.

In some cases, receiving the message indicating the switch comprises receiving the message indicating the switch in one of: an early wake-up signal or an RRC signal or MAC-CE signal.

In some cases, communicating with the UE in step 1020 comprises communicating with the UE using the RFID-based communication mode.

In some cases, communicating using the RFID-based communication mode is based on a period of time in which the UE has no communication with the network entity equaling or exceeding a threshold amount of time. In some cases, communicating using the RFID-based communication mode is based on a beam failure associated with a beam used for communicating with the UE. In some cases, communicating using the RFID-based communication mode is based on a radio link failure between the UE and the network entity.

In some cases, method 1000 further includes switching from communicating with the UE using the RFID-based communication mode to communicating with the UE using the advanced communication mode upon expiration of a timer.

In some cases, method 1000 further includes transmitting a wake-up indication message to the UE indicating to the UE to switch to communicating using the advanced communication mode to receive data from the network entity.

In some cases, the wake-up indication message comprises a sequence of bits. In such cases, method 1000 may further include receiving a response message from the UE based on the wake-up indication message.

In some cases, a sign of the sequence of bits of the wake-up indication message is flipped in the response message. In some cases, a phase shift is applied to the response message relative to a phase of the wake-up indication message.

In some cases, a manner in which the response message is generated differentiates between types of information conveyed by the response message to the network entity.

In some cases, method 1000 further includes receiving, in a backscatter signal associated with the RFID-based communication mode, a wake-up acknowledgement message from the UE based on the wake-up indication message, the wake-up acknowledgement message indicating that the UE will switch to communicating using the advanced communication mode.

In some cases, communicating with the UE in step 1020 comprises: switching from the RFID-based communication mode to the advanced communication mode based on the wake-up acknowledgement message and transmitting the data to the UE using the advanced communication mode.

In some cases, method 1000 further includes transmitting an energy signal to the UE. In such cases, receiving the wake-up acknowledgement message in the backscatter signal comprises receiving a reflected portion of the energy signal from the UE with a preamble or modulation sequence that indicates that the UE will switch to communicating using the advanced EH communication mode.

In some cases, method 1000 further includes receiving, in a backscatter signal associated with the RFID-based communication mode, a wake-up notification message from the UE based on the wake-up indication message, the wake-up notification message indicating that the UE is unable to switch to the advanced communication mode for a period of time.

In some cases, the wake-up notification message comprises an indication of a length of the period of time.

In some cases, method 1000 further includes transmitting an energy signal to the UE. In such cases, receiving the wake-up notification message in the backscatter signal comprises receiving a reflected portion of the energy signal from the UE with a preamble or modulation sequence that indicates that the UE is unable to switch to communicating using the advanced communication mode.

In some cases, method 1000 further includes transmitting an energy signal to the UE for at least the period of time and switching from the RFID-based communication mode to the advanced communication mode after the period of time. In such cases, communicating with the UE in step 1020 comprises using the advanced communication mode to transmit the data to the UE.

In some cases, method 1000 further includes transmitting another wake-up indication message to the UE after the period of time. In such cases, the switching to the advanced communication mode is based on the other wake-up indication message.

In some cases, method 1000 further includes receiving a signal from the UE using the RFID-based communication mode and performing a channel estimation procedure for a channel used for the communication with the UE based on the received signal.

In some cases, performing the channel estimation procedure comprises at least one of: measuring at least one of a time or frequency error associated with communications between the UE and the network entity, performing one or more radio resource management measurements associated with communications between the UE and the network entity, measuring an RSRP associated with communications between the UE and the network entity, or measuring an RSRQ associated with communications between the UE and the network entity.

In some cases, method 1000 further includes generating one or more security keys based on the signal and the channel estimation procedure. In such cases, communicating with the UE in step 1020 is based on the one or more security keys.

In some cases, method 1000 further includes tracking a location of the UE based on the RFID-based communication mode.

In some cases, the advanced communication comprises at least one of LTE-based communication or 5G NR-based communication.

In some cases, communicating with the UE in step 1020 comprises communicating with the UE using the advanced communication mode. In some cases, the advanced communication mode comprises an EH-based communication mode that involves communication based on energy provided based one or more wireless energy sources, including at least one of a solar energy source, a vibration energy source, a thermal energy source, or a RF energy source.

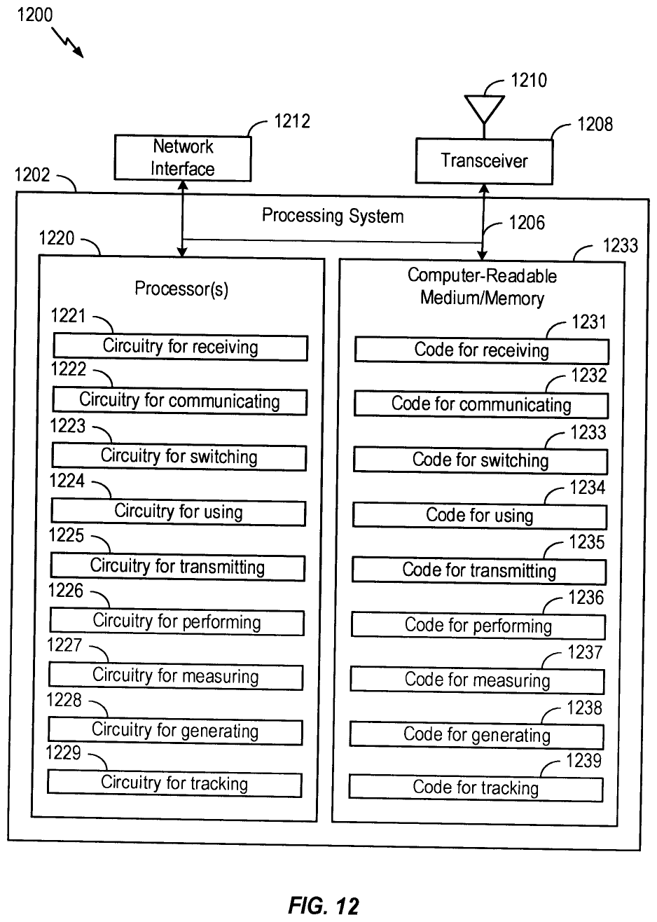

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3. In some cases, the communications device 1100 may be an example of the UE 704 described with respect to FIG. 7.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1140 via a bus 1106. In certain aspects, the computer-readable medium/memory 1140 is configured to store instructions (e.g., computer-executable code) that when executed by the one or more processors 1120, cause the one or more processors 1120 to perform the method 900 described with respect to FIG. 9, or any aspect related to them. Note that reference to a processor performing a function of communications device 1100 may include one or more processors performing that function of communications device 1100.

In the depicted example, computer-readable medium/memory 1140 stores code (e.g., executable instructions) for transmitting 1141, code for communicating 1142, code for switching 1143, code for using 1144, code for receiving 1145, code for generating 1146, code for flipping 1147, code for applying 1148, code for reflecting 1149, code for harvesting 1150, code for storing 1151, code for performing 1152, and code for measuring 1153. Processing of the code 1141-1153 may cause the communications device 1100 to perform the method 900 described with respect to FIG. 9, or any aspect related to them.

The one or more processors 1120 include circuitry configured to implement (e.g., execute) the code stored in the computer-readable medium/memory 1140, including circuitry for transmitting 1121, circuitry for communicating 1122, circuitry for switching 1123, circuitry for using 1124, circuitry for receiving 1125, circuitry for generating 1126, circuitry for flipping 1127, circuitry for applying 1128, circuitry for reflecting 1129, circuitry for harvesting 1130, circuitry for storing 1131, circuitry for performing 1132, and circuitry for measuring 1133. Processing with circuitry 1121-1133 may cause the communications device 1100 to perform the method 900 described with respect to FIG. 9, or any aspect related to them.

Various components of the communications device 1100 may provide means for performing the method 900 described with respect to FIG. 9, or any aspect related to them. For example, means for transmitting, communicating, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11. Means for switching, means for using, means for generating, means for flipping, means for applying, means for reflecting, means for harvesting, means for storing, means for performing, and means for measuring may comprise one or more processors, such controller/processor 380, the transmit processor 364, or the receive processor 358.

FIG. 12 depicts aspects of an example communications device. In some aspects, communications device 1200 is a network entity, such as BS 102 of FIGS. 1 and 3, or a disaggregated base station as discussed with respect to FIG. 2.

The communications device 1200 includes a processing system 1202 coupled to a transceiver 1208 (e.g., a transmitter and/or a receiver) and/or a network interface 1212. The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 2. The processing system 1202 may be configured to perform processing functions for the communications device 1200, including processing signals received and/or to be transmitted by the communications device 1200.

The processing system 1202 includes one or more processors 1220. In various aspects, one or more processors 1220 may be representative of one or more of receive processor 338, transmit processor 320, TX MIMO processor 330, and/or controller/processor 340, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1000 described with respect to FIG. 10, or any aspect related to it. Note that reference to a processor of communications device 1200 performing a function may include one or more processors of communications device 1200 performing that function.

In the depicted example, the computer-readable medium/memory 1230 stores code (e.g., executable instructions) for receiving 1231, code for communicating 1232, code for switching 1233, code for using 1234, code for transmitting 1235, code for performing 1236, code for measuring 1237, code for generating 1238, and code for tracking 1239. Processing of the code 1231-1239 may cause the communications device 1200 to perform the method 1000 described with respect to FIG. 10, or any aspect related to it.

The one or more processors 1220 include circuitry configured to implement (e.g., execute) the code stored in the computer-readable medium/memory 1230, including circuitry for receiving 1221, circuitry for communicating 1222, circuitry for switching 1223, circuitry for using 1224, circuitry for transmitting 1225, circuitry for performing 1226, circuitry for measuring 1227, circuitry for generating 1228, and circuitry for tracking 1229. Processing with circuitry 1221-1229 may cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for transmitting, sending or outputting for transmission may include the transceivers 332 and/or antenna(s) 334 of the BS 102 illustrated in FIG. 3 and/or transceiver 1208 and antenna 1210 of the communications device 1200 in FIG. 12. Means for receiving or obtaining may include the transceivers 332 and/or antenna(s) 334 of the BS 102 illustrated in FIG. 3 and/or transceiver 1208 and antenna 1210 of the communications device 1200 in FIG. 12. Means for switching, means for using, means for performing, means for measuring, means for generating, and means for tracking may comprise one or more processors, such as the controller/processor 340, the transmit processor 320, or the receive processor 338.

### EXAMPLE CLAUSES

Implementation examples are described in the following numbered clauses:

Clause 1: A method for wireless communication by a user equipment (UE), comprising: transmitting, to a network entity, UE capability information indicating that the UE supports a radio frequency identification (RFID)-based communication mode and an advanced communication mode; and communicating with the network entity using at least one of the RFID-based communication mode or the advanced communication mode based on the UE capability information.

Clause 2: The method of Clause 1, wherein communicating with the network entity comprises switching between using the RFID-based communication mode and using the advanced communication mode.

Clause 3: The method of Clause 2, wherein the switching between using the RFID-based communication mode and using the advanced communication mode is based on at least one of a path loss associated with communicating with the network entity or a distance between the UE and network entity.

Clause 4: The method of any one of Clauses 2-3, wherein the switching between using the RFID-based communication mode and using the advanced communication mode is based on an energy level of an energy storage device of the UE.

Clause 5: The method of Clause 4, wherein: communicating with the network entity comprises communicating with the network entity using the RFID-based communication mode; and the method further comprises: determining, while communicating with the network entity using the RFID-based communication mode, the energy level of the energy storage device of the UE is greater than or equal to a threshold energy level; and switching, based on the energy level being greater than or equal to the threshold energy level, from communicating using the RFID-based communication mode to communicating using the advanced communication mode.

Clause 6: The method of Clause 4, wherein: communicating with the network entity comprises communicating with the network entity using the advanced communication mode; and the method further comprises: determining, while communicating with the network entity using the advanced communication mode, the energy level is less than a threshold energy level; and switching, based on the energy level being less than the threshold energy level, from communicating using the advanced communication mode to communicating using the RFID-based communication mode.

Clause 7: The method of any one of Clauses 2-6, further comprising transmitting a message to the network entity indicating the switch between communicating using the RFID-based communication mode and communicating using the advanced communication mode.

Clause 8: The method of Clause 7, wherein transmitting the message indicating the switch comprises transmitting the message indicating the switch in one of: an early wake-up signal; or a radio resource control (RRC) signal or media access control—control element (MAC-CE) signal.

Clause 9: The method of any one of Clauses 1-4, wherein communicating with the network entity comprises communicating with the network entity using the RFID-based communication mode.

Clause 10: The method of Clause 9, wherein communicating with the network entity using the RFID-based communication mode is based on a period of time in which the UE has no communication with the network entity equaling or exceeding a threshold amount of time.

Clause 11: The method of Clause 9, wherein communicating with the network entity using the RFID-based communication mode is based on a beam failure associated with a beam used for communicating with the network entity.

Clause 12: The method of Clause 9, wherein communicating with the network entity using the RFID-based communication mode is based on a radio link failure between the UE and the network entity.

Clause 13: The method of Clause 9, further comprising switching from communicating with the network entity using the RFID-based communication mode to communicating with the network entity using the advanced communication mode upon expiration of a timer.

Clause 14: The method of Clause 9, further comprising receiving, while communicating with the network entity using the RFID-based communication mode, a wake-up indication message from the network entity indicating to the UE to switch from communicating with the network entity using the RFID-based communication mode to communicating using the advanced communication mode to receive data from the network entity.

Clause 15: The method of Clause 14, wherein: the wake-up indication message comprises a sequence of bits, and the method further comprises: generating a response message based on the wake-up indication message; and transmitting the response message to the network entity.

Clause 16: The method of Clause 15, wherein generating the response message comprises one of: flipping a sign of the sequence of bits of the wake-up indication message, or applying a phase shift to the response message relative to a phase of the wake-up indication message.

Clause 17: The method of any one of Clauses 15-16, wherein a manner in which the response message is generated differentiates between types of information conveyed by the response message to the network entity.

Clause 18: The method of any one of Clauses 14-17, further comprising transmitting, using a backscatter signal associated with the RFID-based communication mode, a wake-up acknowledgement message to the network entity based on the received wake-up indication message, the wake-up acknowledgement message indicating that the UE will switch to communicating using the advanced communication mode.

Clause 19: The method of Clause 18, wherein communicating with the network entity comprises: switching from the RFID-based communication mode to the advanced communication mode based on the wake-up indication message, and receiving the data from the network entity using the advanced communication mode.

Clause 20: The method of any one of Clauses 18-19, wherein transmitting the wake-up acknowledgement message using the backscatter signal comprises: receiving an energy signal from the network entity; and reflecting a portion of the received energy signal with a preamble or modulation sequence that indicates that the UE will switch to communicating using the advanced communication mode.

Clause 21: The method of any one of Clauses 14-17, further comprising transmitting, using a backscatter signal associated with the RFID-based communication mode, a wake-up notification message to the network entity based on the received wake-up indication message, the wake-up notification message indicating that the UE is unable to switch to the advanced communication mode for a period of time.

Clause 22: The method of Clause 21, wherein the wake-up notification message comprises an indication of a length of the period of time.

Clause 23: The method of any one of Clauses 21-22, wherein transmitting the wake-up notification message using the backscatter signal comprises: receiving an energy signal from the network entity; and reflecting a portion of the received energy signal with a preamble or modulation sequence that indicates that the UE is unable to switch to the advanced communication mode.

Clause 24: The method of any one of Clauses 21-23, further comprising: receiving an energy signal from the network entity; harvesting energy from the energy signal during the period of time; and storing the harvested energy in an energy storage device of the UE.

Clause 25: The method of Clause 24, further comprising switching from the RFID-based communication mode to the advanced communication mode after the period of time during which the energy is harvested from the energy signal, wherein communicating with the network entity comprises using the advanced communication mode and the stored harvested energy to receive the data from the network entity.

Clause 26: The method of Clause 25, further comprising receiving another wake-up indication message from the network entity after the period of time during which the energy is harvested from the energy signal, wherein the switching to the advanced communication mode is based on the other wake-up indication message.

Clause 27: The method of any one of Clauses 9-26, further comprising: receiving a signal from the network entity using the RFID-based communication mode; and performing a channel estimation procedure for a channel used for the communication with the network entity based on the received signal.

Clause 28: The method of Clause 27, wherein performing the channel estimation procedure comprises at least one of: measuring at least one of a time or frequency error associated with communications between the UE and the network entity, performing one or more radio resource management measurements associated with communications between the UE and the network entity, measuring a reference signal received power (RSRP) associated with communications between the UE and the network entity, or measuring a reference signal received quality (RSRQ) associated with communications between the UE and the network entity.

Clause 29: The method of any one of Clauses 27-28, further comprising generating one or more security keys based on the signal and the channel estimation procedure, wherein communicating with the network entity is based on the one or more security keys.

Clause 30: The method of any one of Clauses 1-29, wherein the advanced communication comprises at least one of long term evolution (LTE)-based communication or fifth generation new radio (5G NR)-based communication.

Clause 31: The method of any one of Clauses 1-30, wherein: communicating with the network entity comprises communicating with the network entity using the advanced communication mode, and the advanced communication mode comprises an energy harvesting (EH)-based communication mode that involves communication based on energy harvested from one or more wireless energy sources, including at least one of a solar energy source, a vibration energy source, a thermal energy source, or a radio frequency (RF) energy source.

Clause 32: A method for wireless communication by a network entity, comprising: receiving, from a user equipment (UE), UE capability information indicating that the UE supports a radio frequency identification (RFID)-based communication mode and an advanced communication mode; and communicating with the UE using at least one of the RFID-based communication mode or the advanced communication mode based on the UE capability information.

Clause 33: The method of Clause 32, wherein communicating with the UE comprises switching between using the RFID-based communication mode and using the advanced communication mode.

Clause 34: The method of Clause 33, wherein the switching between using the RFID-based communication mode and using the advanced communication mode is based on at least one of a path loss associated with communicating with the UE or a distance between the UE and network entity.

Clause 35: The method of any one of Clauses 33-34, further comprising receiving a message from the UE indicating the switch between communicating using the RFID-based communication mode and communicating using the advanced communication mode.

Clause 36: The method of Clause 35, wherein receiving the message indicating the switch comprises receiving the message indicating the switch in one of: an early wake-up signal; or a radio resource control (RRC) signal or media access control-control element (MAC-CE) signal.

Clause 37: The method of any one of Clauses 32-36, wherein communicating with the UE comprises communicating with the UE using the RFID-based communication mode.

Clause 38: The method of Clause 37, wherein communicating with the UE using the RFID-based communication mode is based on a period of time in which the UE has no communication with the network entity equaling or exceeding a threshold amount of time; a beam failure associated with a beam used for communicating with the UE; or a radio link failure between the UE and the network entity.

Clause 39: The method of Clause 37, wherein communicating with the UE using the RFID-based communication mode is based on a beam failure associated with a beam used for communicating with the UE.

Clause 40: The method of Clause 37, wherein communicating with the UE using the RFID-based communication mode is based on a radio link failure between the UE and the network entity.

Clause 41: The method of Clause 37, further comprising switching from communicating with the UE using the RFID-based communication mode to communicating with the UE using the advanced communication mode upon expiration of a timer.

Clause 42: The method of any one of Clauses 37-41, further comprising transmitting a wake-up indication message to the UE indicating to the UE to switch from communicating using the RFID-based communication mode to communicating using the advanced communication mode to receive data from the network entity.

Clause 43: The method of Clause 42, wherein: the wake-up indication message comprises a sequence of bits, and receiving a response message from the UE based on the wake-up indication message.

Clause 44: The method of Clause 43, wherein one of: a sign of the sequence of bits of the wake-up indication message is flipped in the response message, or a phase shift is applied to the response message relative to a phase of the wake-up indication message.

Clause 45: The method of any one of Clauses 43-44, wherein a manner in which the response message is generated differentiates between types of information conveyed by the response message to the network entity.

Clause 46: The method of any one of Clauses 42-45, further comprising receiving, in a backscatter signal associated with the RFID-based communication mode, a wake-up acknowledgement message from the UE based on the wake-up indication message, the wake-up acknowledgement message indicating that the UE will switch to communicating using the advanced communication mode.

Clause 47: The method of Clause 46, wherein communicating with the UE comprises: switching from the RFID-based communication mode to the advanced communication mode based on the wake-up acknowledgement message, and transmitting the data to the UE using the advanced communication mode.

Clause 48: The method of any one of Clauses 46-47, further comprising transmitting an energy signal to the UE, wherein receiving the wake-up acknowledgement message in the backscatter signal comprises receiving a reflected portion of the energy signal from the UE with a preamble or modulation sequence that indicates that the UE will switch to communicating using the advanced EH communication mode.

Clause 49: The method of any one of Clauses 42-45, further comprising receiving, in a backscatter signal associated with the RFID-based communication mode, a wake-up notification message from the UE based on the wake-up indication message, the wake-up notification message indicating that the UE is unable to switch to the advanced communication mode for a period of time.

Clause 50: The method of Clause 49, wherein the wake-up notification message comprises an indication of a length of the period of time.

Clause 51: The method of any one of Clauses 49-50, further comprising transmitting an energy signal to the UE, wherein receiving the wake-up notification message in the backscatter signal comprises receiving a reflected portion of the energy signal from the UE with a preamble or modulation sequence that indicates that the UE is unable to switch to communicating using the advanced communication mode.

Clause 52: The method of any one of Clauses 49-51, further comprising: transmitting an energy signal to the UE for at least the period of time; and switching from the RFID-based communication mode to the advanced communication mode after the period of time, wherein communicating with the UE comprises using the advanced communication mode to transmit the data to the UE.

Clause 53: The method of Clause 52, further comprising transmitting another wake-up indication message to the UE after the period of time, wherein the switching to the advanced communication mode is based on the other wake-up indication message.

Clause 54: The method of any one of Clauses 39-53, further comprising: receiving a signal from the UE using the RFID-based communication mode; and performing a channel estimation procedure for a channel used for the communication with the UE based on the received signal.

Clause 55: The method of Clause 54, wherein performing the channel estimation procedure comprises at least one of: measuring at least one of a time or frequency error associated with communications between the UE and the network entity, performing one or more radio resource management measurements associated with communications between the UE and the network entity, measuring a reference signal received power (RSRP) associated with communications between the UE and the network entity, or measuring a reference signal received quality (RSRQ) associated with communications between the UE and the network entity.

Clause 56: The method of any one of Clauses 54-55, further comprising generating one or more security keys based on the signal and the channel estimation procedure, wherein communicating with the UE is based on the one or more security keys.

Clause 57: The method of any one of Clauses 32-56, further comprising tracking a location of the UE based on the RFID-based communication mode.

Clause 58: The method of any one of Clauses 32-57, wherein the advanced communication comprises at least one of long term evolution (LTE)-based communication or fifth generation new radio (5G NR)-based communication.

Clause 59: The method of any one of Clauses 32-58, wherein: communicating with the UE comprises communicating with the UE using the advanced communication mode, and the advanced communication mode comprises an energy harvesting (EH)-based communication mode that involves communication based on energy provided based one or more wireless energy sources, including at least one of a solar energy source, a vibration energy source, a thermal energy source, or a radio frequency (RF) energy source.

Clause 60: The method of any one of Clauses 14-26, wherein the wake-up indication message indicates to the UE to wake up only a radio associated with the advanced communication mode, both a radio associated with the advanced communication mode and a radio associated with the RFID-based communication mode, or only a radio associated with the RFID-based communication mode.

Clause 61: The method of any one of Clauses 42-52, wherein the wake-up indication message indicates to the UE to wake up only a radio associated with the advanced communication mode, both a radio associated with the advanced communication mode and a radio associated with the RFID-based communication mode, or only a radio associated with the RFID-based communication mode.

Clause 62: An apparatus, comprising: a memory comprising executable instructions; and a processor configured to execute the executable instructions and cause the apparatus to perform a method in accordance with any one of Clauses 1-61.

Clause 63: An apparatus, comprising means for performing a method in accordance with any one of Clauses 1-61.

Clause 64: A non-transitory computer-readable medium comprising executable instructions that, when executed by a processor of an apparatus, cause the apparatus to perform a method in accordance with any one of Clauses 1-61.

Clause 65: A computer program product embodied on a computer-readable storage medium comprising code for performing a method in accordance with any one of Clauses 1-61.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment (UE), comprising:
transmitting, to a network entity, UE capability information indicating that the UE supports a radio frequency identification (RFID)-based communication mode and an advanced communication mode; and
communicating with the network entity using at least one of the RFID-based communication mode or the advanced communication mode based on the UE capability information.

2. The method of claim 1, wherein communicating with the network entity comprises switching between using the RFID-based communication mode and using the advanced communication mode.

3. The method of claim 2, wherein the switching between using the RFID-based communication mode and using the advanced communication mode is based on at least one of a path loss associated with communicating with the network entity or a distance between the UE and network entity.

4. The method of claim 2, wherein the switching between using the RFID-based communication mode and using the advanced communication mode is based on an energy level of an energy storage device of the UE.

5. The method of claim 4, wherein:
communicating with the network entity comprises communicating with the network entity using the RFID-based communication mode; and
the method further comprises:
determining, while communicating with the network entity using the RFID-based communication mode, the energy level of the energy storage device of the UE is greater than or equal to a threshold energy level; and
switching, based on the energy level being greater than or equal to the threshold energy level, from communicating using the RFID-based communication mode to communicating using the advanced communication mode.

6. The method of claim 4, wherein:
communicating with the network entity comprises communicating with the network entity using the advanced communication mode; and
the method further comprises:
determining, while communicating with the network entity using the advanced communication mode, the energy level is less than a threshold energy level; and
switching, based on the energy level being less than the threshold energy level, from communicating using the advanced communication mode to communicating using the RFID-based communication mode.

7. The method of claim 2, further comprising transmitting a message to the network entity indicating the switch between communicating using the RFID-based communication mode and communicating using the advanced communication mode.

8. The method of claim 7, wherein transmitting the message indicating the switch comprises transmitting the message indicating the switch in one of:
an early wake-up signal; or
a radio resource control (RRC) signal or media access control-control element (MAC-CE) signal.

9. The method of claim 1, wherein communicating with the network entity comprises communicating with the network entity using the RFID-based communication mode.

10. The method of claim 9, wherein communicating with the network entity using the RFID-based communication mode is based on at least one of:
a period of time in which the UE has no communication with the network entity equaling or exceeding a threshold amount of time;
a beam failure associated with a beam used for communicating with the network entity; or
a radio link failure between the UE and the network entity.

11. The method of claim 9, further comprising switching from communicating with the network entity using the RFID-based communication mode to communicating with the network entity using the advanced communication mode upon expiration of a timer.

12. The method of claim 9, further comprising receiving, while communicating with the network entity using the RFID-based communication mode, a wake-up indication message from the network entity indicating to the UE to switch from communicating with the network entity using the RFID-based communication mode to communicating using the advanced communication mode to receive data from the network entity.

13. The method of claim 12, wherein:
the wake-up indication message comprises a sequence of bits, and
the method further comprises:
generating a response message based on the wake-up indication message; and
transmitting the response message to the network entity.

14. The method of claim 13, wherein generating the response message comprises one of:
flipping a sign of the sequence of bits of the wake-up indication message, or
applying a phase shift to the response message relative to a phase of the wake-up indication message.

15. The method of claim 13, wherein a manner in which the response message is generated differentiates between types of information conveyed by the response message to the network entity.

16. The method of claim 12, further comprising transmitting, using a backscatter signal associated with the RFID-based communication mode, a wake-up acknowledgement message to the network entity based on the received wake-up indication message, the wake-up acknowledgement message indicating that the UE will switch to communicating using the advanced communication mode.

17. The method of claim 16, wherein communicating with the network entity comprises:
switching from the RFID-based communication mode to the advanced communication mode based on the wake-up indication message, and
receiving the data from the network entity using the advanced communication mode.

18. The method of claim 16, wherein transmitting the wake-up acknowledgement message using the backscatter signal comprises:
receiving an energy signal from the network entity; and
reflecting a portion of the received energy signal with a preamble or modulation sequence that indicates that the UE will switch to communicating using the advanced communication mode.

19. The method of claim 12, further comprising transmitting, using a backscatter signal associated with the RFID-based communication mode, a wake-up notification message to the network entity based on the received wake-up indication message, the wake-up notification message indicating that the UE is unable to switch to the advanced communication mode for a period of time.

20. The method of claim 19, wherein the wake-up notification message comprises an indication of a length of the period of time.

21. The method of claim 19, wherein transmitting the wake-up notification message using the backscatter signal comprises:
receiving an energy signal from the network entity; and
reflecting a portion of the received energy signal with a preamble or modulation sequence that indicates that the UE is unable to switch to the advanced communication mode.

22. The method of claim 19, further comprising:
receiving an energy signal from the network entity;
harvesting energy from the energy signal during the period of time; and
storing the harvested energy in an energy storage device of the UE.

23. The method of claim 22, further comprising switching from the RFID-based communication mode to the advanced communication mode after the period of time during which the energy is harvested from the energy signal, wherein communicating with the network entity comprises using the advanced communication mode and the stored harvested energy to receive the data from the network entity.

24. The method of claim 23, further comprising receiving another wake-up indication message from the network entity after the period of time during which the energy is harvested from the energy signal, wherein the switching to the advanced communication mode is based on the other wake-up indication message.

25. The method of claim 9, further comprising:
receiving a signal from the network entity using the RFID-based communication mode; and
performing a channel estimation procedure for a channel used for the communication with the network entity based on the received signal.

26. The method of claim 25, wherein performing the channel estimation procedure comprises at least one of:
measuring at least one of a time or frequency error associated with communications between the UE and the network entity,
performing one or more radio resource management measurements associated with communications between the UE and the network entity,
measuring a reference signal received power (RSRP) associated with communications between the UE and the network entity, or
measuring a reference signal received quality (RSRQ) associated with communications between the UE and the network entity.

27. The method of claim 25, further comprising generating one or more security keys based on the signal and the channel estimation procedure, wherein communicating with the network entity is based on the one or more security keys.

28. The method of claim 1, wherein the advanced communication comprises at least one of long term evolution (LTE)-based communication or fifth generation new radio (5G NR)-based communication.

29. The method of claim 1, wherein:
communicating with the network entity comprises communicating with the network entity using the advanced communication mode, and
the advanced communication mode comprises an energy harvesting (EH)-based communication mode that involves communication based on energy harvested from one or more wireless energy sources, including at least one of a solar energy source, a vibration energy source, a thermal energy source, or a radio frequency (RF) energy source.

30. A user equipment (UE), comprising:
a memory comprising executable instructions; and
a processor configured to execute the executable instructions and cause the UE to:
transmit, to a network entity, UE capability information indicating that the UE supports a radio frequency identification (RFID)-based communication mode and an advanced communication mode; and
communicate with the network entity using at least one of the RFID-based communication mode or the advanced communication mode based on the UE capability information.
